(19) United States
(12) Patent Application Publication
(10) Pub. No.: US 2024/0283142 A1
(43) Pub. Date: Aug. 22, 2024

(54) VEHICULAR ANTENNA DEVICE

(71) Applicant: YOKOWO CO., LTD., Tokyo (JP)

(72) Inventors: Bunpei HARA, Tomioka-shi (JP); Seiya HIROKI, Tomioka-shi (JP); Tsuyoshi KOMORI, Tomioka-shi (JP)

(73) Assignee: YOKOWO CO., LTD., Tokyo (JP)

(21) Appl. No.: 18/645,712

(22) Filed: Apr. 25, 2024

Related U.S. Application Data
(63) Continuation-in-part of application No. PCT/JP2022/038896, filed on Oct. 19, 2022.

(30) Foreign Application Priority Data
Oct. 25, 2021 (JP) 2021-173607

(51) Int. Cl. H01Q 1/32; H01Q 1/42

(52) U.S. Cl. CPC H01Q 1/3275; H01Q 1/42

(57) ABSTRACT

A vehicular antenna device including a cover, and a plurality of monopole antennas accommodated in an accommodation space formed by the cover, in which the plurality of monopole antennas is arranged in a direction intersecting a desired direction.

### CROSS-REFERENCE TO RELATED APPLICATIONS

This application is a Bypass Continuation-in-Part of PCT Application No. PCT/JP2022/038896, filed on Oct. 19, 2022, which claims priority to JP 2021-173607, filed Oct. 25, 2021, the entire contents of each are incorporated herein by reference.

### BACKGROUND

The present invention relates to a vehicular antenna device.

### BACKGROUND ART

In recent years, various vehicular antenna devices including a Vehicle-to-everything (V2X) antenna have been developed. For example, a vehicular antenna device described in Patent Document 1 includes a plurality of dipole antennas. The plurality of dipole antennas is arranged in a front-rear direction of a vehicle.
Patent Document 1: Japanese Unexamined Patent Publication No. 2020-198593

### SUMMARY

It may be required to enhance the directivity of an antenna accommodated in an accommodation space formed by a cover in a desired direction. For example, when the antenna accommodated in the accommodation space is a V2X antenna, it is required to enhance the directivity of the V2X antenna in the front-rear direction of the vehicle. To enhance the directivity of the V2X antenna in the front-rear direction of the vehicle, for example, a plurality of dipole antennas may be used as disclosed in Patent Document 1. A configuration of the dipole, however, may be relatively complicated. Meanwhile, a frequency in a 5.9 MHz band may be used in the V2X antenna. In this case, a wavelength of the frequency used in the V2X antenna is relatively short. It is therefore required to make the configuration of the V2X antenna relatively simple.

An example of the object of the present invention is to enhance the directivity of the antenna accommodated in the accommodation space formed by the cover in the desired direction with a simple configuration. Other objects of the present invention will become apparent from the description herein.

An aspect of the present invention is a vehicular antenna device including: a cover; and a plurality of monopole antennas accommodated in an accommodation space formed by the cover, in which the plurality of monopole antennas is arranged in a direction intersecting a desired direction.

An aspect of the present invention is a vehicular antenna device including: a cover; a monopole antenna accommodated in an accommodation space formed by the cover; and a parasitic element accommodated in the accommodation space, in which the monopole antenna and the parasitic element are arranged in a direction intersecting a desired direction.

An aspect of the present invention is a vehicular antenna device including: a cover; a monopole antenna accommodated in an accommodation space formed by the cover; and a parasitic element accommodated in the accommodation space, in which the monopole antenna and the parasitic element are arranged along a desired direction.

An aspect of the present invention is a vehicular antenna device including: a cover; an antenna element accommodated in an accommodation space formed by the cover; and a pair of capacitive loading elements accommodated in the accommodation space and disposed in a direction intersecting a desired direction, in which at least a portion of the antenna element is located between the pair of capacitive loading elements.

According to the above aspects of the present invention, the directivity of the antenna accommodated in the accommodation space formed by the cover can be enhanced in the desired direction with a simple configuration.

### BRIEF DESCRIPTION OF THE DRAWINGS

FIG. 1 is a perspective view of a vehicular antenna device according to Embodiment 1.

FIG. 2 is a perspective view of an antenna portion according to Embodiment 1.

FIG. 3 is perspective view of a vehicular antenna device according to Comparative Example 1.

FIG. 4 is a perspective view of an antenna portion according to Comparative Example 1.

FIG. 5 is a graph showing directivity in the horizontal plane of an array antenna in the vehicular antenna device according to Embodiment 1.

FIG. 6 is a graph showing directivity in the horizontal plane of the array antenna in the antenna portion according to Embodiment 1.

FIG. 7 is a graph showing directivity in the horizontal plane of a monopole antenna in the vehicular antenna device according to Comparative Example 1.

FIG. 8 is a graph showing directivity in the horizontal plane of the monopole antenna in the antenna portion according to Comparative Example 1.

FIG. 9 is a perspective view of a vehicular antenna device according to Embodiment 2.

FIG. 10 is a perspective view of an antenna portion according to Embodiment 2.

FIG. 11 is a graph showing directivity in the horizontal plane of a monopole antenna in the vehicular antenna device according to Embodiment 2.

FIG. 12 is a graph showing directivity in the horizontal plane of the monopole antenna in the antenna portion according to Embodiment 2.

FIG. 13 is a perspective view of a vehicular antenna device according to Embodiment 3.

FIG. 14 is a perspective view of an antenna portion according to Embodiment 3.

FIG. 15 is a graph showing directivity in the horizontal plane of a monopole antenna in the vehicular antenna device according to Embodiment 3.

FIG. 16 is a graph showing directivity in the horizontal plane of the monopole antenna in the antenna portion according to Embodiment 3.

FIG. 17 is a perspective view of a vehicular antenna device according to Embodiment 4.

FIG. 18 is a perspective view of an antenna portion according to Embodiment 4.

FIG. 19 is a graph showing directivity in the horizontal plane of a monopole antenna in the vehicular antenna device according to Embodiment 4.

FIG. 20 is a graph showing directivity in the horizontal plane of the monopole antenna in the antenna portion according to Embodiment 4.

FIG. 21 is a perspective view of a vehicular antenna device according to Embodiment 5.

FIG. 22 is an enlarged top view of a collinear array antenna and a pair of first capacitive loading elements in a vehicular antenna device according to Embodiment 5.

FIG. 23 is an enlarged top view of a collinear array antenna and a pair of first capacitive loading elements in a vehicular antenna device according to a variant.

FIG. 24 is a graph showing directivity in the horizontal plane of a collinear array antenna in each of the vehicular antenna device according to Embodiment 5, the vehicular antenna device according to the variant, and a vehicular antenna device according to Comparative Example 2.

FIG. 25 is an enlarged top view of the collinear array antenna and a pair of first capacitive loading elements in a vehicular antenna device according to Comparative Example 2.

FIG. 26 is a perspective view of a vehicular antenna device according to Embodiment 6.

FIG. 27 is a perspective view of a vehicle in which a vehicular antenna device according to Embodiment 7 is mounted.

FIG. 28 is an exploded perspective view of the vehicular antenna device according to Embodiment 7.

### DETAILED DESCRIPTION OF EXEMPLIFIED EMBODIMENTS

Hereinafter, embodiments and variants of the present invention will be described with reference to the drawings. In all drawings, the same constituent components are denoted by the same reference signs, and detailed explanation thereof will not be repeated.

In the present specification, ordinal numbers, such as “first”, “second”, and “third”, are attached only for distinguishing components to which the same names are attached unless otherwise specified, and do not mean particular features (for example, an order or a degree of importance) of the components.

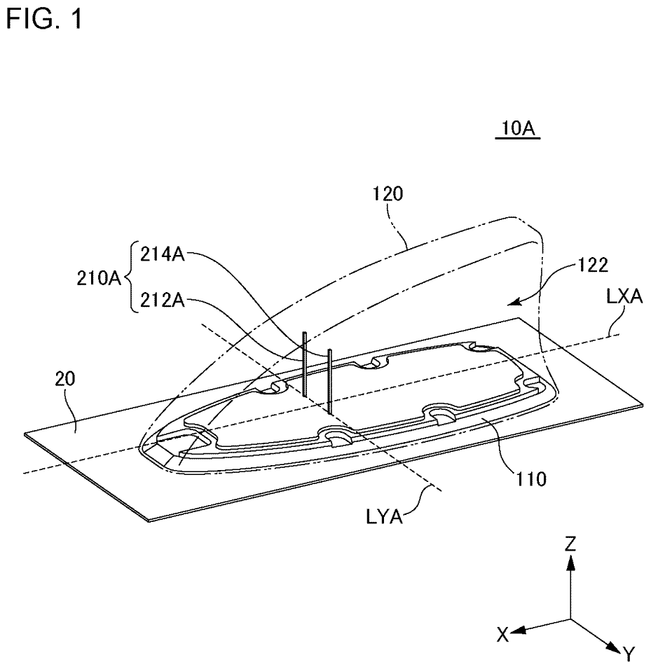

FIG. 1 is a perspective view of a vehicular antenna device 10A according to Embodiment 1.

In FIG. 1, an arrow indicating a first direction X, a second direction Y, or a third direction Z indicates that a direction from a base end toward a tip of the arrow is a positive direction of a direction indicated by the arrow, and a direction from the tip toward the base end of the arrow is a negative direction of the direction indicated by the arrow.

The first direction X is a direction parallel to the front-rear direction of a vehicular antenna device 10A. The positive direction of the first direction X is a direction from the rear to the front of the vehicular antenna device 10A. The negative direction of the first direction X is a direction from the front to the rear of the vehicular antenna device 10A. The second direction Y is orthogonal to the first direction X. The second direction Y is a direction parallel to the left-right direction of the vehicular antenna device 10A. The positive direction of the second direction Y is a direction from the right to the left of the vehicular antenna device 10A when viewed from the rear of the vehicular antenna device 10A. The negative direction of the second direction Y is a direction from the left to the right of the vehicular antenna device 10A when viewed from the rear of the vehicular antenna device 10A. The third direction Z is orthogonal to both the first direction X and the second direction Y. The third direction Z is a direction parallel to the up-down direction of the vehicular antenna device 10A. The positive direction of the third direction Z is a direction from the lower side to the upper side of the vehicular antenna device 10A. The negative direction of the third direction Z is a direction from the upper side to the lower side of the vehicular antenna device 10A. Unless otherwise specified herein, a desired direction means a direction to enhance a directivity of an antenna.

Unless otherwise specified, the vehicular antenna device 10A is descried as being mounted over a vehicle. The vehicular antenna device 10A includes an antenna base 110, also simply referred to as a base 110, a cover 120, also referred to as an antenna case 120, and an array antenna 210A. The array antenna 210A includes a first monopole antenna 212A and a second monopole antenna 214A. In FIG. 1, for the sake of description, the base 110 and the array antenna 210A are shown to be transmitted through the cover 120.

The base 110 is provided on an upper surface side of a ground plate 20. The base 110 has, for example, at least one of a metal base and a resin base. The base 110 has a first surface on an upper side of the base 110. The first surface of the base 110 may be also referred as an upper surface of the base 110. The ground plate 20 is, for example, a roof of an automobile. Hereinafter, unless otherwise specified, the ground plate 20 extends infinitely in a direction perpendicular to the third direction Z.

The cover 120 has a radio wave transmission property. The cover 120 is made of, for example, resin. The cover 120 forms an accommodation space 122 together with the base 110. The first monopole antenna 212A and the second monopole antenna 214A are accommodated in the accommodation space 122. That is, the cover 120 is a radome of the first monopole antenna 212A and the second monopole antenna 214A. The cover 120 covers the accommodation space 122 from above the accommodation space 122. The first monopole antenna 212A and the second monopole antenna 214A are located within the upper surface of the base 110 in the plan view from the normal direction of the upper surface of the base 110.

A height of the cover 120 in the third direction Z increases from a front end of the cover 120 toward a rear end of the cover 120. Accordingly, a height of the accommodation space 122 in the third direction Z also increases from the front end of the cover 120 toward the rear end of the cover 120.

A length of the cover 120 in the first direction X is longer than a length of the cover 120 in the second direction Y. That is, the cover 120 has a longitudinal direction in the first direction X, which corresponds to a length of the cover 120 in the front-rear direction of the vehicle, and a lateral direction in the second direction Y, which corresponds to a length of the cover 120 in the left-right direction of the vehicle. Thus, a length of the accommodation space 122 in the first direction X is also longer than a length of the accommodation space 122 in the second direction Y.

The directivity of the array antenna 210A is affected by the cover 120. Specifically, the directivity of the array antenna 210A in a direction that has a relatively short distance from the array antenna 210A to an inner wall of the cover 120 is relatively hardly affected by the cover 120. The directivity of the array antenna 210A in a direction that has a relatively long distance from the array antenna 210A to an inner wall of the cover 120, on the other hand, is relatively easily affected by the cover 120. Accordingly, the directivity of a monopole antenna in the second direction Y is relatively enhanced, and the directivity of the monopole antenna in the first direction X is relatively weakened, for example, when the single monopole antenna is disposed near the center in the first direction X and the second direction Y of the upper surface of the base 110 when viewed from the third direction Z. In other words, the directivity of the monopole antenna in the second direction Y is relatively enhanced and the directivity of the monopole antenna in the first direction X is relatively weakened when the single monopole antenna is disposed near the center of the base 110, which may be also referred to as a geometric center of the base 110, located at the intersection between the central axis of the base 110 in the longitudinal direction corresponding to the first direction X and the central axis of the base 110 in the lateral direction corresponding to the second direction Y. According to Embodiment 1, on the other hand, the directivity of the array antenna 210A in the desired direction such as the first direction X can be enhanced even if the array antenna 210A is accommodated in the accommodation space 122.

The first monopole antenna 212A and the second monopole antenna 214A according to Embodiment 1 are ½ wavelength monopole antennas. The configurations of the first monopole antenna 212A and the second monopole antenna 214A can be made simpler than the configurations of other antennas such as dipole antennas. According to Embodiment 1, the array antenna 210A can have therefore a relatively simple configuration.

The first monopole antenna 212A and the second monopole antenna 214A are provided on the upper surface side of the ground plate 20. The first monopole antenna 212A and the second monopole antenna 214A are disposed substantially perpendicular to the ground plate 20. A lower end of the first monopole antenna 212A facing the ground plate 20 serves as a feeding portion of the first monopole antenna 212A. A lower end of the second monopole antenna 214A facing the ground plate 20 serves as a feeding portion for the second monopole antenna 214A. A wavelength of the frequency used in the array antenna 210A is defined as λ_{A}. A length of the first monopole antenna 212A in the third direction Z and a length of the second monopole antenna 214A in the third direction Z are substantially equal to ½ times the wavelength λ_{A}.

The first monopole antenna 212A and the second monopole antenna 214A are arranged in a direction intersecting the first direction X. Specifically, the first monopole antenna 212A is located on a right side of a virtual center line LXA, and the second monopole antenna 214A is located on a left side of the virtual center line LXA. When viewed from the third direction Z, the virtual center line LXA passes in the first direction X through the center in the second direction Y of the upper surface of the base 110. That is, the virtual center line LXA may also be a central axis of the base 110 in the longitudinal direction corresponding to the first direction X. When viewed from the third direction Z, the first monopole antenna 212A and the second monopole antenna 214A are arranged on a virtual intersection line LYA. The virtual intersection line LYA intersects the virtual center line LXA, and passes in the second direction Y through the first monopole antenna 212A and the second monopole antenna 214A. That is, the virtual intersection line LYA may also be a straight line along the lateral direction of the base 110 intersecting the central axis of the base 110 in the longitudinal direction.

The first monopole antenna 212A and the second monopole antenna 214A are located substantially symmetrically with respect to the virtual center line LXA. In other words, when viewed from the third direction Z, the virtual center line LXA is a perpendicular bisector of a virtual line segment connecting the first monopole antenna 212A and the second monopole antenna 214A. Accordingly, it is possible to reduce a difference between an influence on the directivity of the array antenna 210A from the inner wall of the cover 120 on a right side of the accommodation space 122 and an influence on the directivity of the array antenna 210A from the inner wall of the cover 120 on a left side of the accommodation space 122.

A distance in the second direction Y between the first monopole antenna 212A and the second monopole antenna 214A is, for example, substantially equal to ½ times the wavelength λ_{A}. For example, the distance in the second direction Y between the first monopole antenna 212A and the second monopole antenna 214A may be equal to or greater than ⅜ times and equal to or less than ⅝ times the wavelength λ_{A}.

The distance in the second direction Y between the first monopole antenna 212A and the second monopole antenna 214A may be, for example, substantially equal to ¼ times the wavelength λ_{A}. For example, a distance in the second direction Y between the first monopole antenna 212A and the second monopole antenna 214A may be equal to or greater than ⅛ times and equal to or less than ⅜ times the wavelength λ_{A}.

Between the first monopole antenna 212A and the second monopole antenna 214A, interference between a radio wave radiated from the first monopole antenna 212A and a radio wave radiated from the second monopole antenna 214A occurs. This can enhance the directivity of the array antenna 210A in the direction intersecting the virtual line segment connecting the first monopole antenna 212A and the second monopole antenna 214A when viewed from the positive direction of the third direction Z. Specifically, it is possible to enhance the directivity of the array antenna 210A in the first direction X on the virtual center line LXA when viewed from the positive direction of the third direction Z. The directivity of the array antenna 210A in a desired direction can be therefore enhanced.

Specifically, the first monopole antenna 212A and the second monopole antenna 214A are spaced apart from each other along the second direction Y by a predetermined distance. The first monopole antenna 212A and the second monopole antenna 214A are supplied with power at the substantially the same amplitude and substantially the same phase, and are excited substantially at the same time. This makes no phase difference between the radio wave radiated from the first monopole antenna 212A toward the virtual center line LXA and the radio wave radiated from the second monopole antenna 214A toward the virtual center line LXA when viewed from the positive direction of the third direction Z. Accordingly, the directivity of the first monopole antenna 212A toward the first direction X and the directivity of the second monopole antenna 214A toward the first direction X are constructive on the virtual center line LXA when viewed from the positive direction of the third direction Z. Meanwhile, there is a phase difference between the radio wave radiated from the first monopole antenna 212A toward the direction of the second direction Y and the radio wave radiated from the second monopole antenna 214A toward the second direction Y. Accordingly, the directivity of the first monopole antenna 212A toward the second direction Y and the directivity of the second monopole antenna 214A in the second direction Y are destructive.

For example, a case where the distance in the second direction Y between the first monopole antenna 212A and the second monopole antenna 214A is ½ times the wavelength λ_{A} will be described. In this case, the radio wave radiated from the first monopole antenna 212A in the second direction Y and the radio wave radiated from the second monopole antenna 214A in the second direction Y are substantially in antiphase, and the radio wave radiated from the first monopole antenna 212A in the second direction Y and the radio wave radiated from the second monopole antenna 214A in the second direction Y cancel each other. The directivity of the array antenna 210A in the second direction Y is therefore weakened. Meanwhile, the phase difference does not occur between the radio wave radiated from the first monopole antenna 212A toward the virtual center line LXA and the radio wave radiated from the second monopole antenna 214A toward the virtual center line LXA when viewed from the positive direction of the third direction Z. The directivity of the array antenna 210A in the first direction X is therefore enhanced by overlapping the radio wave radiated from the first monopole antenna 212A in the first direction X and the radio wave radiated from the second monopole antenna 214A in the first direction X on the virtual center line LXA when viewed from the positive direction of the third direction Z.

As described above, the first monopole antenna 212A and the second monopole antenna 214A are arranged along a direction substantially perpendicular to the first direction X. From the above description, in Embodiment 1, the directivity of the array antenna 210A in the first direction X can be further enhanced as compared with a case where the first monopole antenna 212A and the second monopole antenna 214A are arranged in a direction different from the direction substantially perpendicular to the first direction X.

As described above, when the distance in the second direction Y between the first monopole antenna 212A and the second monopole antenna 214A is substantially equal to ½ times the wavelength λ_{A}, the directivity of the array antenna 210A in the second direction Y can be further weakened, and the directivity of the array antenna 210A in the first direction X can be further enhanced as compared with a case where the distance in the second direction Y between the first monopole antenna 212A and the second monopole antenna 214A are different from ½ times the wavelength λ_{A}. The distance in the second direction Y between the first monopole antenna 212A and the second monopole antenna 214A, however, is not limited to the above-described example. The distance in the second direction Y between the first monopole antenna 212A and the second monopole antenna 214A can be changed as appropriate depending on a distance from the inner wall of the cover 120 to a region where the array antenna 210A is disposed.

A position of the array antenna 210A in the first direction X is located at or around the center in the first direction X of the upper surface of the base 110. In other words, the position of the array antenna 210A in the first direction X is located at or around the midpoint of the length in the first direction X of the base 110. Accordingly, it is possible to reduce a difference between an influence on the directivity of the array antenna 210A from the inner wall of the cover 120 on a front side of the accommodation space 122 and an influence on the directivity of the array antenna 210A from the inner wall of the cover 120 on a rear side of the accommodation space 122. For example, when viewed from the third direction Z, the array antenna 210A may be located at the center of the upper surface of the base 110 in the first direction X or at a distance of 45% or less of the total length in the first direction X from the center of the upper surface of the base 110. That is, the position of the array antenna 210A is located at the midpoint of the length of the base 110 in the longitudinal direction or at a distance of 45% or less of the total length in the first direction X of the base 110 from the midpoint of the length in the first direction X of the base 110.

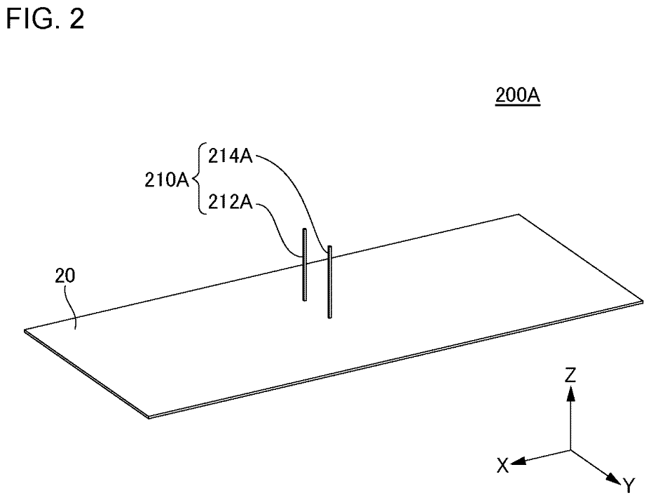

FIG. 2 is a perspective view of an antenna portion 200A according to Embodiment 1. The antenna portion 200A according to Embodiment 1 is the same as the vehicular antenna device 10A according to Embodiment 1 except for the following points.

The antenna portion 200A according to Embodiment 1 does not include the base 110 and the cover 120. The antenna portion 200A according to Embodiment 1 includes an array antenna 210A as in the vehicular antenna device 10A according to Embodiment 1.

FIG. 2 illustrates a configuration of the array antenna 210A not accommodated in the accommodation space 122. FIG. 2 is a view for comparing the directivity of the array antenna 210A accommodated in the accommodation space 122 as shown in FIG. 1 and the directivity of the array antenna 210A not accommodated in the accommodation space 122 as shown in FIG. 2.

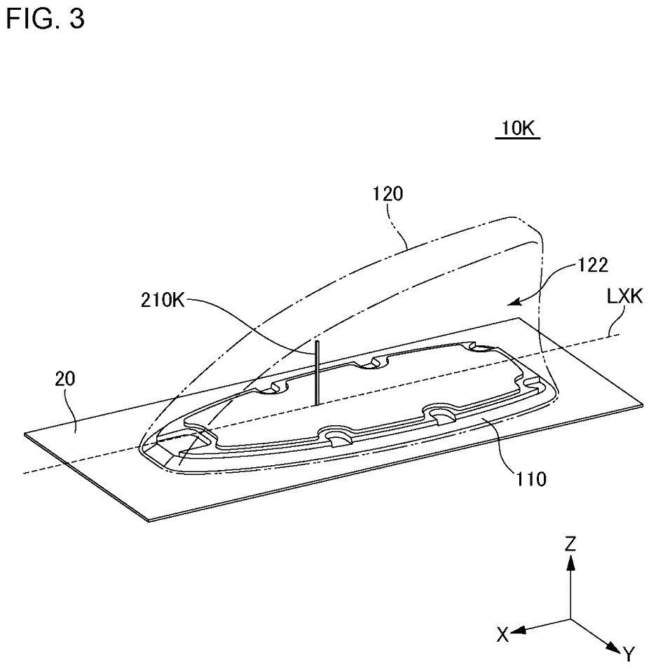

FIG. 3 is a perspective view of a vehicular antenna device 10K according to Comparative Example 1. The vehicular antenna device 10K according to Comparative Example 1 is the same as the vehicular antenna device 10A according to Embodiment 1 except for the following points.

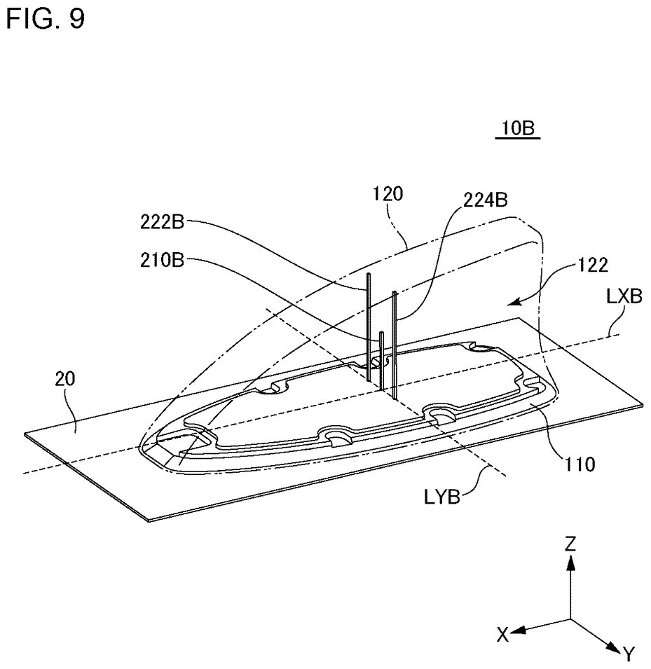

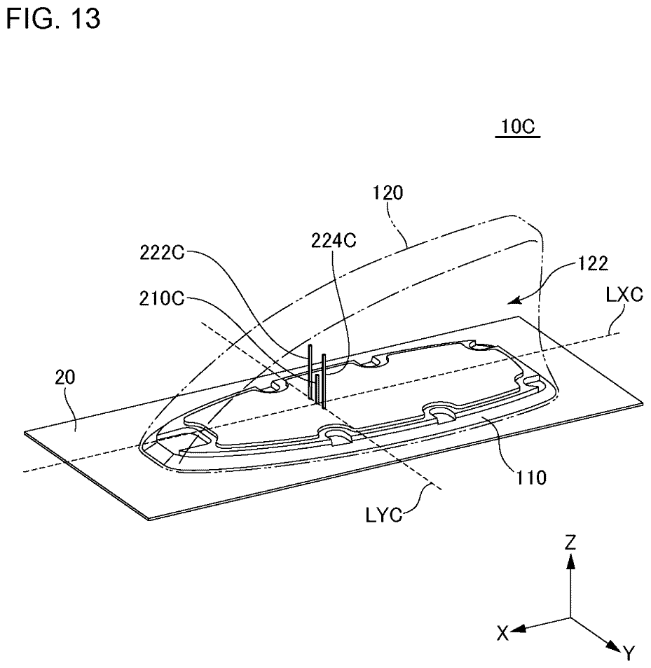

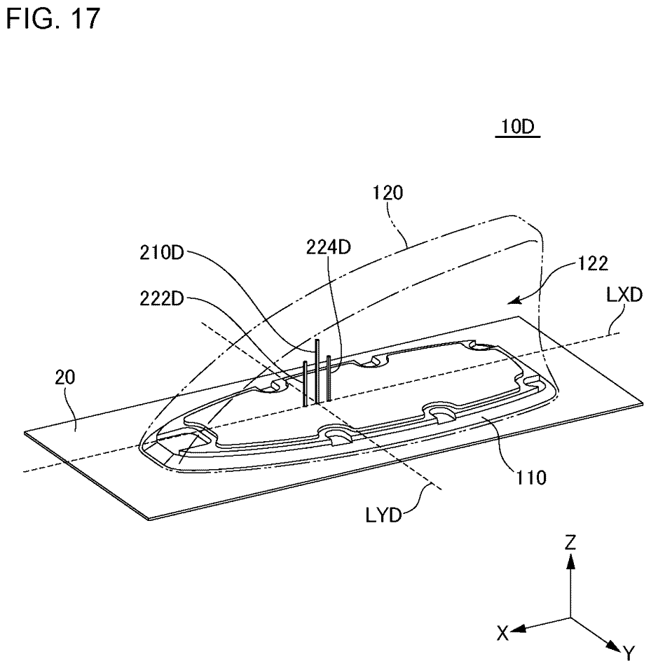

The vehicular antenna device 10K according to Comparative Example 1 includes a single monopole antenna 210K. FIG. 3 is a view for comparing the vehicular antenna device 10K according to Comparative Example 1 of FIG. 3 with each of the vehicular antenna device 10A according to Embodiment 1 of FIG. 1, a vehicular antenna device 10B according to Embodiment 2 of FIG. 9, which will be described later, a vehicular antenna device 10C according to Embodiment 3 of FIG. 13, which will be described later, and a vehicular antenna device 10D according to Embodiment 4 of FIG. 17, which will be described later.

The single monopole antenna 210K is a ½ wavelength monopole antenna. Specifically, the single monopole antenna 210K is provided on the upper surface side of the ground plate 20. The single monopole antenna 210K is disposed substantially perpendicular to the ground plate 20. A lower end of the single monopole antenna 210K facing the ground plate 20 serves as a feeding portion of the single monopole antenna 210K. When viewed from the third direction Z, the single monopole antenna 210K is located on a virtual center line LXK. The virtual center line LXK passes in parallel with the first direction X through the substantial center in the second direction Y of the upper surface of the base 110. A wavelength of the frequency used in the single monopole antenna 210K is defined as λ_{K}. A length of the single monopole antenna 210K in the third direction Z is substantially equal to ½ times the wavelength λ_{K}.

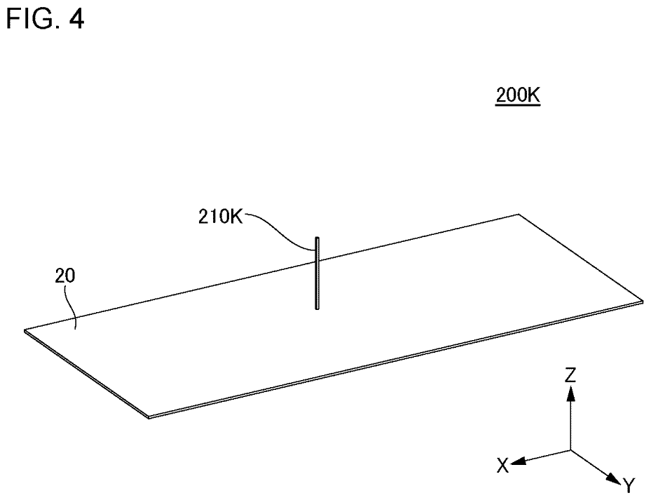

FIG. 4 is a perspective view of an antenna portion 200K according to Comparative Example 1. The antenna portion 200K according to Comparative Example 1 is the same as the vehicular antenna device 10K according to Comparative Example 1 except for the following points.

The antenna portion 200K according to Comparative Example 1 does not include the base 110 and the cover 120. The antenna portion 200K according to Comparative Example 1 includes a single monopole antenna 210K as in the vehicular antenna device 10K according to Comparative Example 1.

FIG. 4 is a view illustrating a configuration of the single monopole antenna 210K not accommodated in the accommodation space 122. FIG. 4 is a view for comparing the directivity of the single monopole antenna 210K accommodated in the accommodation space 122 as shown in FIG. 3 and the directivity of the single monopole antenna 210K not accommodated in the accommodation space 122 as shown in FIG. 4.

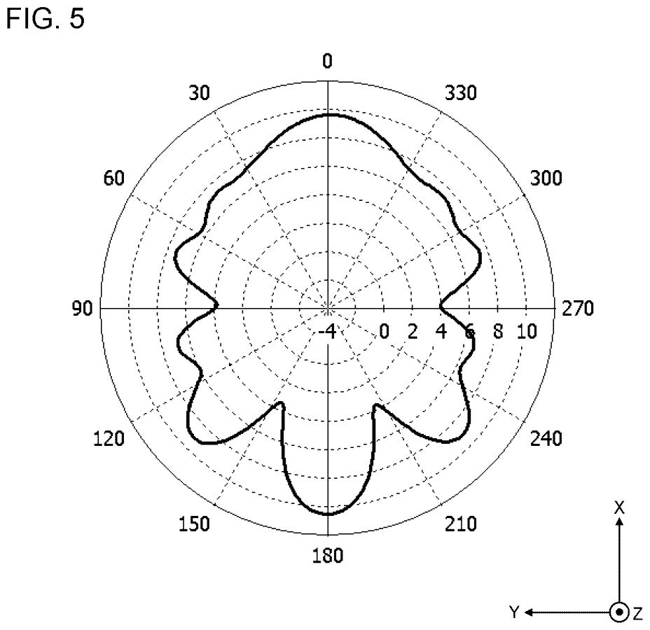

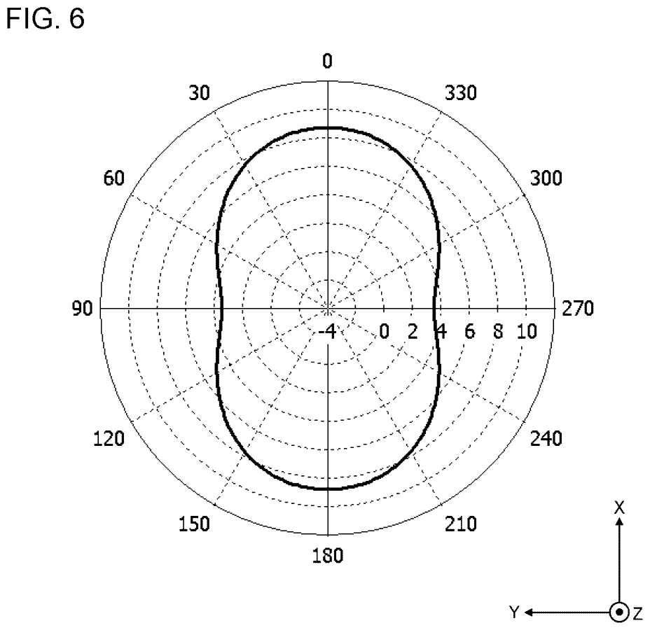

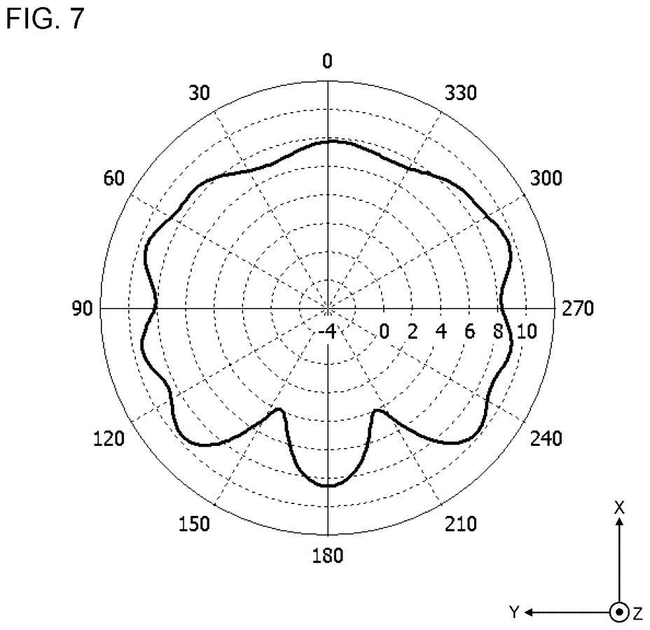

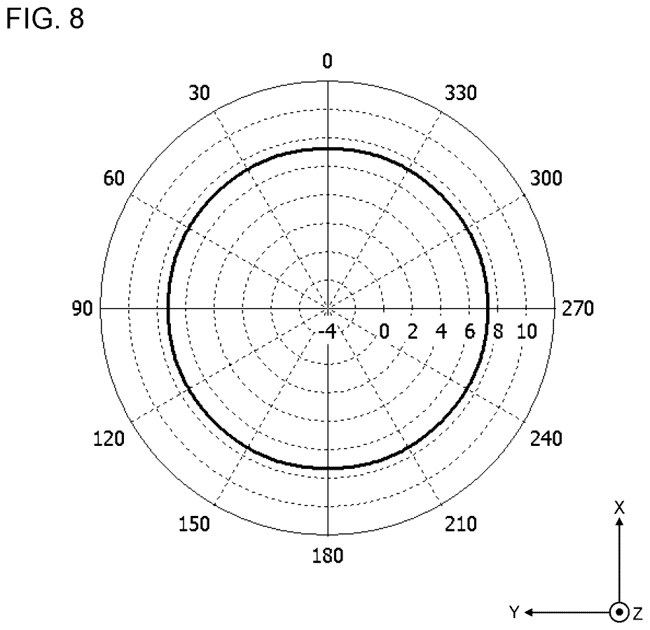

FIG. 5 is a graph showing directivity in the horizontal plane of the array antenna 210A in the vehicular antenna device 10A according to Embodiment 1. FIG. 6 is a graph showing directivity in the horizontal plane of the array antenna 210A in the antenna portion 200A according to Embodiment 1. FIG. 7 is a graph showing directivity in the horizontal plane of the single monopole antenna 210K in the vehicular antenna device 10K according to Comparative Example 1. FIG. 8 is a graph showing directivity in the horizontal plane of the single monopole antenna 210K in the antenna portion 200K according to Comparative Example 1.

In the description of FIGS. 5 to 8, the term “horizontal plane” means a plane perpendicular to the third direction Z. The graphs of FIGS. 5 and 6 show the directivity in the horizontal plane of 5900 MHz, which is a frequency used in the array antenna 210A. The graphs of FIGS. 7 and 8 show the directivity in the horizontal plane of 5900 MHz, which is a frequency used in the single monopole antenna 210K.

In FIGS. 5 to 8, the numbers attached to an outer periphery of a graph indicate directions (unit: °) in the horizontal plane. The angles of 0°, 180°, 90°, and 270° are the front direction, the rear direction, the left direction, and the right direction, respectively. In FIGS. 5 to 8, broken circles shown concentrically with respect to the center of the graph indicate sensitivity (unit: dBi) of the antenna. In FIGS. 5 to 8, a white circle with a black dot indicating that a third direction Z shows that a direction from a back side toward a front side of a paper surface is the positive direction of the third direction Z, and a direction from the front side toward the back side of the paper surface is the negative direction of the third direction Z.

The condition of the vehicular antenna device 10A according to Embodiment 1 shown in FIG. 5 and the condition of the antenna portion 200A according to Embodiment 1 shown in FIG. 6 were as follows. That is, the total length of the cover 120 in the first direction X was 180 mm. The lengths of the first monopole antenna 212A and the second monopole antenna 214A in the third direction Z were 28.5 mm. The first monopole antenna 212A and the second monopole antenna 214A were arranged in the second direction Y. The first monopole antenna 212A and the second monopole antenna 214A were located symmetrically with respect to the virtual center line LXA. The distance in the second direction Y between the first monopole antenna 212A and the second monopole antenna 214A was 16 mm. The distance in the first direction X from the front end of the cover 120 to the array antenna 210A was 70 mm.

The condition of the vehicular antenna device 10K according to Comparative Example 1 shown in FIG. 7 and the condition of the antenna portion 200K according to Comparative Example 1 shown in FIG. 8 were the same as the condition of the vehicular antenna device 10A according to Embodiment 1 shown in FIG. 5 and the condition of the antenna portion 200A according to Embodiment 1 shown in FIG. 6, except for the following points. That is, the length of the single monopole antenna 210K in the third direction Z was 28.5 mm. When viewed from the third direction Z, the single monopole antenna 210K was located on the virtual center line LXK. The distance in the first direction X from the front end of the cover 120 to the single monopole antenna 210K was 70 mm.

As shown in FIG. 8, in the antenna portion 200K according to Comparative Example 1 with the single monopole antenna 210K not accommodated in the accommodation space 122, the directivity of the single monopole antenna 210K is about 7 dBi in all directions. Accordingly, the directivity of the single monopole antenna 210K is all orientations (non-directivity) in the horizontal plane with the single monopole antenna 210K not accommodated in the accommodation space 122.

As shown in FIG. 7, in the vehicular antenna device 10K according to Comparative Example 1 with the single monopole antenna 210K accommodated in the accommodation space 122, the directivity of the single monopole antenna 210K is about 7 dBi to 8 dBi around 0°±30°, about 4 dBi to 9 dBi around 180°±30°, and about 8 dBi to 10 dBi around 90°±30° and around 270°±30°. Accordingly, the directivity of the single monopole antenna 210K in the positive direction and the negative direction of the first direction X is less than the directivity of the single monopole antenna 210K in the positive direction and the negative direction of the second direction Y when the single monopole antenna 210K is accommodated in the accommodation space 122.

From the results shown in FIGS. 7 and 8, the directivity of the single monopole antenna 210K would be affected by the cover 120. Specifically, a distance from the single monopole antenna 210K to the inner wall of the cover 120 on both sides of the accommodation space 122 in the second direction Y is shorter than any of a distance from the single monopole antenna 210K to the inner wall of the cover 120 on a positive direction side of the accommodation space 122 in the first direction X and a distance from the single monopole antenna 210K to the inner wall of the cover 120 on a negative direction side of the accommodation space 122 in the first direction X. Accordingly, the directivity of the single monopole antenna 210K in a direction that has a relatively short distance from the single monopole antenna 210K to the inner wall of the cover 120 would tend to be greater than the directivity of the single monopole antenna 210K in a direction that has a relatively long distance from the single monopole antenna 210K to the inner wall of the cover 120 when the single monopole antenna 210K is accommodated in the accommodation space 122.

In Embodiment 1, as shown in FIG. 6, when the array antenna 210A is not accommodated in the accommodation space 122, the directivity of the array antenna 210A is about 8 dBi to 9 dBi around 0°±30° and around 180°±30°, and about 3 dBi to 5 dBi around 90°±30° and around 270°±30°. Accordingly, the directivity of the array antenna 210A in the positive direction and the negative direction of the first direction X can be greater than the directivity of the array antenna 210A in the positive direction and the negative direction of the second direction Y when the array antenna 210A is not accommodated in the accommodation space 122. That is, the directivity of the array antenna 210A in the first direction X, which is the desired direction, can be enhanced with the array antenna 210A not accommodated in the accommodation space 122.

In Embodiment 1, as shown in FIG. 5, when the array antenna 210A is accommodated in the accommodation space 122, the directivity of the array antenna 210A is about 7 dBi to 10 dBi around 0°±30°, about 4 dBi to 11 dBi around 180°±30°, and about 4 dBi to 7 dBi around 90°±30° and around 270°±30°. Accordingly, the directivity of the array antenna 210A in the positive direction and the negative direction of the first direction X can be greater than the directivity of the array antenna 210A in the positive direction and the negative direction of the second direction Y when the array antenna 210A is accommodated in the accommodation space 122. That is, the directivity of the array antenna 210A in the first direction X, which is the desired direction, can be enhanced with the array antenna 210A accommodated in the accommodation space 122.

As can be seen from FIG. 6 of Embodiment 1 and FIG. 8 of Comparative Example 1, the directivity of the array antenna 210A in the positive direction and the negative direction of the second direction Y according to Embodiment 1 with the array antenna 210A not accommodated in the accommodation space 122 is less than the directivity of the single monopole antenna 210K in the positive direction and the negative direction of the second direction Y according to Comparative Example 1 with the single monopole antenna 210K not accommodated in the accommodation space 122. The directivity of the array antenna 210A in the positive direction and the negative direction of the first direction X according to Embodiment 1 with the array antenna 210A not accommodated in the accommodation space 122 is greater than the directivity of the single monopole antenna 210K in the positive direction and the negative direction of the first direction X according to Comparative Example 1 with the single monopole antenna 210K not accommodated in the accommodation space 122.

As can be seen from FIG. 5 of Embodiment 1 and FIG. 7 of Comparative Example 1, the directivity of the array antenna 210A in the positive direction and the negative direction of the second direction Y according to Embodiment 1 with the array antenna 210A accommodated in the accommodation space 122 is less than the directivity of the single monopole antenna 210K in the positive direction and the negative direction of the second direction Y according to Comparative Example 1 with the single monopole antenna 210K accommodated in the accommodation space 122. The directivity of the array antenna 210A in the positive direction and the negative direction of the first direction X according to Embodiment 1 with the array antenna 210A accommodated in the accommodation space 122 is greater than the directivity of the single monopole antenna 210K in the positive direction and the negative direction of the first direction X according to Comparative Example 1 with the single monopole antenna 210K accommodated in the accommodation space 122.

The configuration of the array antenna 210A is not limited to the configuration described using Embodiment 1.

For example, at least one of the first monopole antenna 212A and the second monopole antenna 214A may be displaced from the virtual intersection line LYA to the front side or the rear side. In this case, a distance in the second direction Y between the first monopole antenna 212A and the virtual center line LXA and a distance in the second direction Y between the second monopole antenna 214A and the virtual center line LXA may be different from each other. Appropriately adjusting predetermined conditions such as arrangement and dimensions of the first monopole antenna 212A and the second monopole antenna 214A can make the directivity of the array antenna 210A in at least one of the positive direction and the negative direction of the first direction X greater than the directivity of the array antenna 210A in at least one of the positive direction and the negative direction of the second direction Y.

The array antenna 210A may include three or more monopole antennas. For example, when viewed from the third direction Z, four monopole antennas may be disposed at four vertices of a quadrangle that has two sides parallel to the first direction X and two sides parallel to the second direction Y. In the quadrangle in this example, for example, a length of the two sides parallel to the second direction Y may be longer than a length of the two sides parallel to the first direction X.

The first monopole antenna 212A and the second monopole antenna 214A may be ¼ wavelength monopole antennas. The first monopole antenna 212A and the second monopole antenna 214A are not limited to a linear shape, but may have a plate shape.

FIG. 9 is a perspective view of a vehicular antenna device 10B according to Embodiment 2. The vehicular antenna device 10B according to Embodiment 2 is the same as the vehicular antenna device 10A according to Embodiment 1 except for the following points.

The vehicular antenna device 10B according to Embodiment 2 includes a monopole antenna 210B, a first parasitic element 222B, and a second parasitic element 224B. The monopole antenna 210B, the first parasitic element 222B, and the second parasitic element 224B are accommodated in the accommodation space 122. The monopole antenna 210B, the first parasitic element 222B, and the second parasitic element 224B are located within the upper surface of the base 110 in the plan view from the normal direction of the upper surface of the base 110.

The monopole antenna 210B according to Embodiment 2 is a ½ wavelength monopole antenna. Specifically, the monopole antenna 210B is provided on the upper surface side of the ground plate 20. The monopole antenna 210B is disposed substantially perpendicular to the ground plate 20. A lower end of the monopole antenna 210B facing the ground plate 20 serves as a feeding portion for the monopole antenna 210B. A wavelength of the frequency used in the monopole antenna 210B is defined as λ_{B}. A length of the monopole antenna 210B in the third direction Z is substantially equal to ½ times the wavelength λ_{B}.

When viewed from the third direction Z, the monopole antenna 210B is located on a virtual center line LXB. That is, the virtual center line LXB may also be a central axis of the base 110 in the longitudinal direction corresponding to the first direction X. The virtual center line LXB passes in parallel with the first direction X through the substantial center in the second direction Y of the upper surface of the base 110. Accordingly, it is possible to reduce a difference between an influence on the directivity of the monopole antenna 210B from the inner wall of the cover 120 on a right side of the accommodation space 122 and an influence on the directivity of the monopole antenna 210B from the inner wall of the cover 120 on a left side of the accommodation space 122.

The first parasitic element 222B and the second parasitic element 224B are non-grounded to the ground plate 20. Specifically, a lower end of the first parasitic element 222B and a lower end of the second parasitic element 224B are not connected to the ground plate 20. One of the first parasitic element 222B and the second parasitic element 224B, however, may be grounded to the ground plate 20. That is, at least one of the first parasitic element 222B and the second parasitic element 224B may be non-grounded to the ground plate 20.

A length of the first parasitic element 222B in the third direction Z and a length of the second parasitic element 224B in the third direction Z are longer than a length of the monopole antenna 210B in the third direction Z. In Embodiment 2, the length of the first parasitic element 222B in the third direction Z and the length of the second parasitic element 224B in the third direction Z are substantially equal to the wavelength λ_{B}.

The first parasitic element 222B and the second parasitic element 224B are located on opposite sides of the virtual center line LXB in the second direction Y. The monopole antenna 210B and the first parasitic element 222B are therefore arranged in a direction intersecting the first direction X. The monopole antenna 210B and the second parasitic element 224B are also arranged in the direction intersecting the first direction X. Specifically, the first parasitic element 222B is located on a right side of the virtual center line LXB. Thus, the first parasitic element 222B is located between a right inner wall of the cover 120 and the monopole antenna 210B. The second parasitic element 224B is located on a left side of the virtual center line LXB. Thus, the second parasitic element 224B is located between a left inner wall of the cover 120 and the monopole antenna 210B. The first parasitic element 222B and the second parasitic element 224B can operate as reflective elements to reflect a radio wave radiated from the monopole antenna 210B. The directivity of the monopole antenna 210B in a desired direction can be therefore enhanced. Specifically, the first parasitic element 222B and the second parasitic element 224B can make the directivity of the monopole antenna 210B in at least one of the positive direction and the negative direction of the second direction Y greater than the directivity of the monopole antenna 210B in at least one of the positive direction and the negative direction of the first direction X.

The monopole antenna 210B, the first parasitic element 222B, and the second parasitic element 224B are arranged in a direction substantially perpendicular to the first direction X. Specifically, when viewed from the third direction Z, the monopole antenna 210B, the first parasitic element 222B, and the second parasitic element 224B are located on a virtual intersection line LYB. The virtual intersection line LYB intersects the virtual center line LXB, and passes through the monopole antenna 210B in the second direction Y. That is, the virtual intersection line LYB may also be a straight line along the lateral direction of the base 110 intersecting the center axis of the base 110 in the longitudinal direction. Accordingly, the directivity of the monopole antenna 210B in at least one of the positive direction and the negative direction of the second direction Y can be further weakened, and the directivity of the monopole antenna 210B in at least one of the positive direction and the negative direction of the first direction X can be further enhanced as compared with a case where the monopole antenna 210B, the first parasitic element 222B, and the second parasitic element 224B are arranged in a direction different from the direction substantially perpendicular to the first direction X.

A distance in the second direction Y between the first parasitic element 222B and the second parasitic element 224B is shorter than a length of the first parasitic element 222B in the third direction Z and a length of the second parasitic element 224B in the third direction Z. The distance in the second direction Y between the first parasitic element 222B and the second parasitic element 224B is substantially equal to ½ times the wavelength λ_{B}.

The first parasitic element 222B and the second parasitic element 224B are located at a substantially equal distance from the monopole antenna 210B. The length of the first parasitic element 222B in the third direction Z and the length of the second parasitic element 224B in the third direction Z are substantially equal to each other. The arrangement and dimensions of the first parasitic element 222B and the second parasitic element 224B, however, are not limited to the arrangement and dimensions according to Embodiment 2. For example, a distance between the monopole antenna 210B and the first parasitic element 222B and a distance between the monopole antenna 210B and the second parasitic element 224B may be different from each other. In this case, the length of the first parasitic element 222B in the third direction Z and the length of the second parasitic element 224B in the third direction Z may be different from each other. Appropriately adjusting the arrangement and dimensions of the first parasitic element 222B and the second parasitic element 224B can enhance the directivity of the monopole antenna 210B in the first direction X.

As in Embodiment 1, a position of the monopole antenna 210B in the first direction X is located at or around the center in the first direction X of the upper center of the base 110. In other words, the position of the array antenna 210B in the first direction X is located at or around the midpoint of the length of the base 110 in the longitudinal direction. Accordingly, it is possible to reduce a difference between an influence on the directivity of the monopole antenna 210B from the inner wall of the cover 120 on the front side of the accommodation space 122 and an influence on the directivity of the monopole antenna 210B from the inner wall of the cover 120 on the rear side of the accommodation space 122.

The monopole antenna 210B, the first parasitic element 222B, and the second parasitic element 224B can be mounted with various structures. For example, the vehicular antenna device 10B may include a resin holder that holds the monopole antenna 210B, the first parasitic element 222B, and the second parasitic element 224B. Alternatively, the vehicular antenna device 10B may include a substrate on which the monopole antenna 210B, the first parasitic element 222B, and the second parasitic element 224B are provided as a conductive pattern. Each of the monopole antenna 210B, the first parasitic element 222B, and the second parasitic element 224B is not limited to a linear shape, but may have a plate shape.

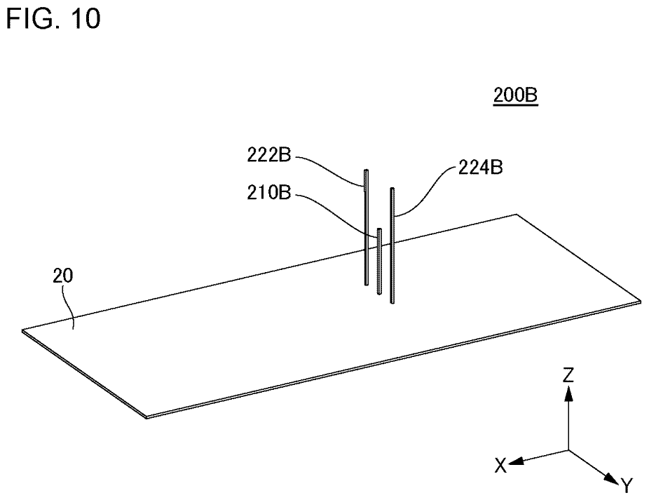

FIG. 10 is a perspective view of an antenna portion 200B according to Embodiment 2. The antenna portion 200B according to Embodiment 2 is the same as the vehicular antenna device 10B according to Embodiment 2 except for the following points.

The antenna portion 200B according to Embodiment 2 does not include the base 110 and the cover 120. The antenna portion 200B according to Embodiment 2 includes the monopole antenna 210B, the first parasitic element 222B, and the second parasitic element 224B as in the vehicular antenna device 10B according to Embodiment 2.

FIG. 10 shows configurations of the monopole antenna 210B, the first parasitic element 222B, and the second parasitic element 224B that are not accommodated in the accommodation space 122. FIG. 10 is a view for comparing the directivity of the monopole antenna 210B accommodated in the accommodation space 122 as shown in FIG. 9 and the directivity of the monopole antenna 210B not accommodated in the accommodation space 122 as shown in FIG. 10.

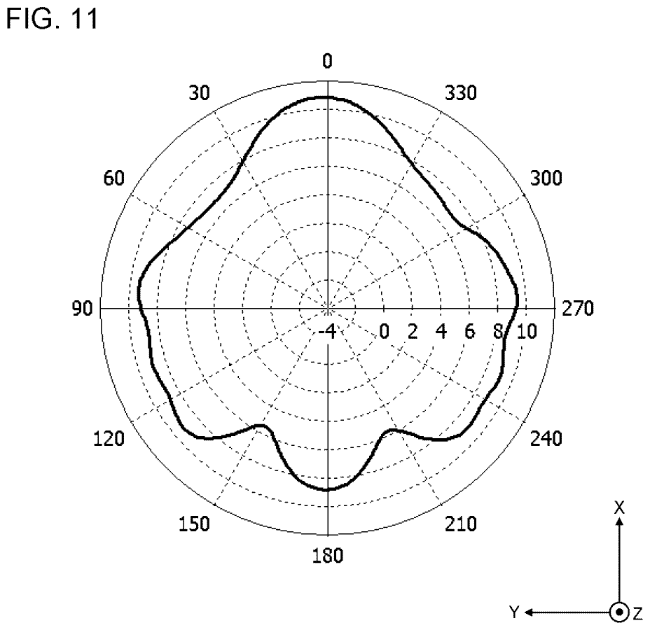

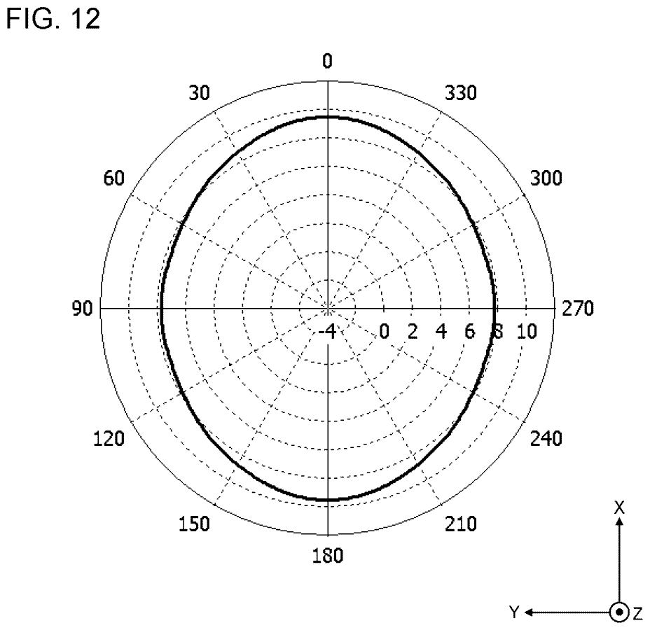

FIG. 11 is a graph showing directivity in the horizontal plane of the monopole antenna 210B in the vehicular antenna device 10B according to Embodiment 2. FIG. 12 is a graph showing directivity in the horizontal plane of the monopole antenna 210B in the antenna portion 200B according to Embodiment 2.

The graphs of FIGS. 11 and 12 show the directivity in the horizontal plane of 5900 MHz, which is a frequency used in the monopole antenna 210B.

The condition of the vehicular antenna device 10B according to Embodiment 2 shown in FIG. 11 and the condition of the antenna portion 200B according to Embodiment 2 shown in FIG. 12 were the same as the condition of the vehicular antenna device 10A according to Embodiment 1 shown in FIG. 5 and the condition of the antenna portion 200A according to Embodiment 1 shown in FIG. 6, except for the following points. That is, a height of the monopole antenna 210B in the third direction Z was 25.3 mm. A height of each of the first parasitic element 222B and the second parasitic element 224B in the third direction Z was 47 mm. The monopole antenna 210B, the first parasitic element 222B, and the second parasitic element 224B were arranged in the second direction Y. When viewed from the third direction Z, the monopole antenna 210B was located on a virtual center line LXB. The first parasitic element 222B and the second parasitic element 224B were located at the equal distance from the monopole antenna 210B. A distance in the second direction Y between the first parasitic element 222B and the second parasitic element 224B was 21 mm. A distance in the first direction X from the front end of the cover 120 to the monopole antenna 210B, the first parasitic element 222B, and the second parasitic element 224B was 110 mm.

In Embodiment 2, as shown in FIG. 12, when the monopole antenna 210B is not accommodated in the accommodation space 122, the directivity of the monopole antenna 210B is about 9 dBi to 10 dBi around 0°±30° and around 180°±30°, and about 8 dBi around 90°±30° and around 270°±30°. Accordingly, the first parasitic element 222B and the second parasitic element 224B would make the directivity of the monopole antenna 210B in the positive direction and the negative direction of the first direction X greater than the directivity of the monopole antenna 210B in the positive direction and the negative direction of the second direction Y when the monopole antenna 210B is not accommodated in the accommodation space 122.

In Embodiment 2, as shown in FIG. 11, when the monopole antenna 210B is accommodated in the accommodation space 122, the directivity of the monopole antenna 210B is about 8 dBi to 11 dBi around 0°±30°, and about 8 dBi to 10 dBi around 90°±30° and around 270°±30°. Accordingly, the first parasitic element 222B and the second parasitic element 224B would make the directivity of the monopole antenna 210B in the positive direction of the first direction X greater than the directivity of the monopole antenna 210B in the positive direction and the negative direction of the second direction Y when the monopole antenna 210B is accommodated in the accommodation space 122.

As can be seen from FIG. 12 of Embodiment 2 and FIG. 8 of Comparative Example 1, the directivity of the monopole antenna 210B in the positive direction and the negative direction of the first direction X according to Embodiment 2 with the monopole antenna 210B not accommodated in the accommodation space 122 is greater than the directivity of the single monopole antenna 210K in the positive direction and the negative direction of the first direction X according to Comparative Example 1 with the single monopole antenna 210K not accommodated in the accommodation space 122.

As can be seen from FIG. 11 of Embodiment 2 and FIG. 7 of Comparative Example 1, the directivity of the monopole antenna 210B in the positive direction of the first direction X according to Embodiment 2 with the monopole antenna 210B accommodated in the accommodation space 122 is greater than the directivity of the single monopole antenna 210K in the positive direction of the first direction X according to Comparative Example 1 with the single monopole antenna 210K accommodated in the accommodation space 122.

The configurations of the monopole antenna 210B, the first parasitic element 222B, and the second parasitic element 224B are not limited to the configurations described using Embodiment 2.

For example, at least one of the first parasitic element 222B and the second parasitic element 224B may be displaced from the virtual intersection line LYB to the front side or the rear side. For example, the vehicular antenna device 10B may be a composite antenna having an antenna other than the monopole antenna 210B. In this case, the antenna other than the monopole antenna 210B may need displacement of the monopole antenna 210B from the virtual center line LXB to the left side or the right side. The first parasitic element 222B and the second parasitic element 224B may be therefore offset from the virtual intersection line LYB according to the displacement of the monopole antenna 210B from the virtual center line LXB. Appropriately arranging the monopole antenna 210B, the first parasitic element 222B and the second parasitic element 224B can make the directivity of the monopole antenna 210B in at least one of the positive direction and the negative direction of the first direction X greater than the directivity of the monopole antenna 210B in at least one of the positive direction and the negative direction of the second direction Y.

The monopole antenna 210B may be displaced from the virtual intersection line LYB to the front side or the rear side. The displacement of the monopole antenna 210B from the virtual intersection line LYB to the positive direction or the negative direction of the first direction X can adjust a ratio between the directivity of the monopole antenna 210B in the positive direction of the first direction X and the directivity of the monopole antenna 210B in the negative direction of the first direction X. For example, when the monopole antenna 210B is displaced from the virtual intersection line LYB to the negative direction of the first direction X, the directivity of the monopole antenna 210B in the positive direction of the first direction X can be greater than the directivity of the monopole antenna 210B in the negative direction of the first direction X. When the monopole antenna 210B is displaced from the virtual intersection line LYB to the positive direction of the first direction X, the directivity of the monopole antenna 210B in the negative direction of the first direction X can be greater than the directivity of the monopole antenna 210B in the positive direction of the first direction X.

There may be only one parasitic element provided to one monopole antenna 210B. For example, the parasitic element is disposed toward the direction intersecting the first direction X with respect to the monopole antenna 210B. Thus, the monopole antenna 210B and the parasitic element are arranged in the direction intersecting the first direction X. Accordingly, the directivity of the monopole antenna 210B in the first direction X can be greater than the directivity of the monopole antenna 210B in the first direction X when the monopole antenna 210B and the parasitic element are arranged in the direction different from the first direction X. In this example, the monopole antenna 210B and the parasitic element may be arranged in the direction substantially perpendicular to the first direction X. In this case, the directivity of the monopole antenna 210B in the first direction X can be further enhanced as compared with a case where the monopole antenna 210B and the parasitic element are arranged in a direction different from the direction substantially perpendicular to the first direction X.

There may be three or more parasitic elements provided to one monopole antenna 210B. For example, when viewed from the third direction Z, four parasitic elements may be disposed at four vertices of a quadrangle that has two sides parallel to the first direction X and two sides parallel to the second direction Y, and the monopole antenna 210B may be disposed at the center of the quadrangle. Also in this example, adjusting the arrangement of the four parasitic elements in consideration of a predetermined condition such as a phase of a radio wave radiated from the monopole antenna 210B can make the directivity of the monopole antenna 210B in at least one of the positive direction and the negative direction of the first direction X greater than the directivity of the monopole antenna 210B in at least one of the positive direction and the negative direction of the second direction Y.

FIG. 13 is a perspective view of the vehicular antenna device 10C according to Embodiment 3. The vehicular antenna device 10C according to Embodiment 3 is the same as the vehicular antenna device 10B according to Embodiment 2 except for the following points.

The vehicular antenna device 10C according to Embodiment 3 includes a monopole antenna 210C, a first parasitic element 222C, and a second parasitic element 224C. The monopole antenna 210C, the first parasitic element 222C, and the second parasitic element 224C are located within the upper surface of the base 110 in the plan view from the normal direction of the upper surface of the base 110.

The monopole antenna 210C according to Embodiment 3 is a ¼ wavelength monopole antenna. Specifically, a wavelength of the frequency used in the monopole antenna 210C is defined as λ_{C}. The length of the monopole antenna 210C in the third direction Z is substantially equal to ¼ times the wavelength λ_{C}. When viewed from the third direction Z, the monopole antenna 210C is located on a virtual center line LXC. The virtual center line LXC is a central axis of the base 110 in the longitudinal direction corresponding to the first direction X.

The first parasitic element 222C and the second parasitic element 224C are non-grounded to the ground plate 20. A length of the first parasitic element 222C in the third direction Z and a length of the second parasitic element 224C in the third direction Z are longer than a length of the monopole antenna 210C in the third direction Z. In Embodiment 3, the length of the first parasitic element 222C in the third direction Z and the length of the second parasitic element 224C in the third direction Z are substantially equal to ½ times the wavelength λ_{C}. One of the first parasitic element 222C and the second parasitic element 224C, however, may be grounded to the ground plate 20. That is, at least one of the first parasitic element 222C and the second parasitic element 224C may be non-grounded to the ground plate 20.

When viewed from the third direction Z, the monopole antenna 210C, the first parasitic element 222C, and the second parasitic element 224C are located on a virtual intersection line LYC. The virtual intersection line LYC is a straight line along the lateral direction of the base 110 intersecting the central axis of the base 110 in the longitudinal direction. The monopole antenna 210C and the first parasitic element 222C are therefore arranged in a direction intersecting the first direction X. The monopole antenna 210C and the second parasitic element 224C are also arranged in the direction intersecting the first direction X. Specifically, the first parasitic element 222C is located on a right side of the virtual center line LXC. Thus, the first parasitic element 222C is located between a right inner wall of the cover 120 and the monopole antenna 210C. The second parasitic element 224C is located on a left side of the virtual center line LXC. Thus, the second parasitic element 224C is located between a left inner wall of the cover 120 and the monopole antenna 210C. A distance in the second direction Y between the first parasitic element 222C and the second parasitic element 224C is shorter than a length of the first parasitic element 222C in the third direction Z and a length of the second parasitic element 224C in the third direction Z. Specifically, in Embodiment 3, a distance in the second direction Y between the first parasitic element 222C and the second parasitic element 224C is substantially equal to ¼ times the wavelength λ_{C}. The first parasitic element 222C and the second parasitic element 224C are located at a substantially equal distance from the monopole antenna 210C.

As in the first parasitic element 222B and the second parasitic element 224B according to Embodiment 2, the first parasitic element 222C and the second parasitic element 224C can operate as reflective elements to reflect a radio wave radiated from the monopole antenna 210C. The directivity of the monopole antenna 210B in a desired direction can be therefore enhanced.

In Embodiment 3, the length of the monopole antenna 210C in the third direction Z, the length of the first parasitic element 222C in the third direction Z, and the length of the second parasitic element 224C in the third direction Z can be shorter as compared with Embodiment 2. Accordingly, the monopole antenna 210C, the first parasitic element 222C, and the second parasitic element 224C can be disposed at a lower height position of the cover 120 as compared with Embodiment 2. Specifically, the monopole antenna 210C, the first parasitic element 222C, and the second parasitic element 224C can be disposed closer to the front side of the cover 120 as compared with Embodiment 2.

In Embodiment 3, the distance in the second direction Y between the first parasitic element 222C and the second parasitic element 224C can be shortened as compared with Embodiment 2. Accordingly, a space in the second direction Y required for disposing the monopole antenna 210C, the first parasitic element 222C, and the second parasitic element 224C can be further reduced as compared with Embodiment 2.

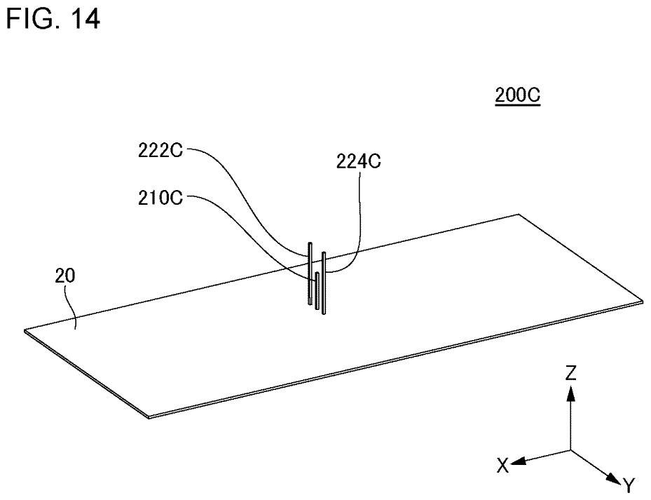

FIG. 14 is a perspective view of an antenna portion 200C according to Embodiment 3. The antenna portion 200C according to Embodiment 3 is the same as the vehicular antenna device 10C according to Embodiment 3 except for the following points.

The antenna portion 200C according to Embodiment 3 does not include the base 110 and the cover 120. The antenna portion 200C according to Embodiment 3 includes the monopole antenna 210C, the first parasitic element 222C, and the second parasitic element 224C as in the vehicular antenna device 10C according to Embodiment 3. The monopole antenna 210C, the first parasitic element 222C, and the second parasitic element 224C are accommodated in the accommodation space 122.

FIG. 14 shows configurations of the monopole antenna 210C, the first parasitic element 222C, and the second parasitic element 224C that are not accommodated in the accommodation space 122. FIG. 14 is a view for comparing the directivity of the monopole antenna 210C accommodated in the accommodation space 122 as shown in FIG. 13 and the directivity of the monopole antenna 210C not accommodated in the accommodation space 122 as shown in FIG. 14.

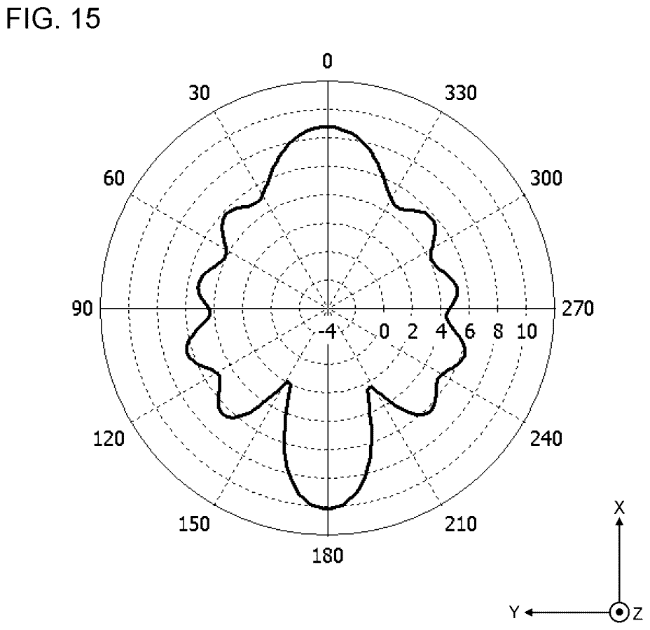

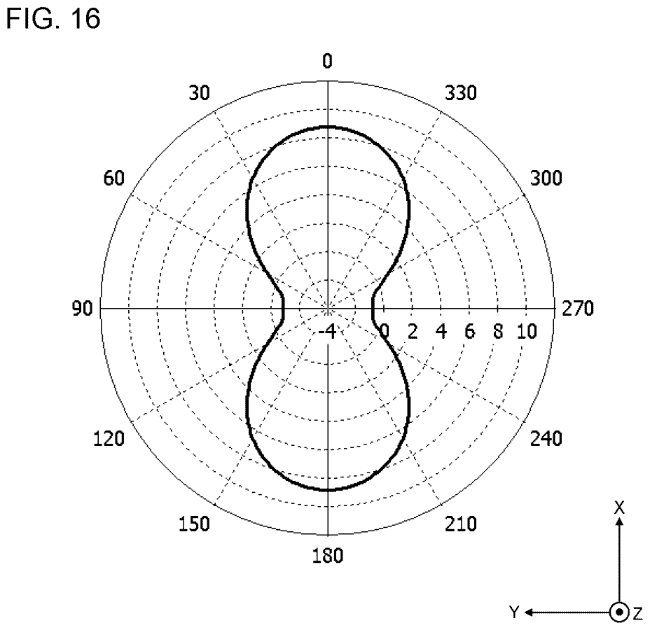

FIG. 15 is a graph showing directivity in the horizontal plane of the monopole antenna 210C in the vehicular antenna device 10C according to Embodiment 3. FIG. 16 is a graph showing directivity in the horizontal plane of the monopole antenna 210C in the antenna portion 200C according to Embodiment 3.

The graphs of FIGS. 15 and 16 show the directivity in the horizontal plane of 5900 MHz, which is a frequency used in the monopole antenna 210C.

The condition of the vehicular antenna device 10C according to Embodiment 3 shown in FIG. 15 and the condition of the antenna portion 200C according to Embodiment 3 shown in FIG. 16 were the same as the condition of the vehicular antenna device 10B according to Embodiment 2 shown in FIG. 11 and the condition of the antenna portion 200B according to Embodiment 2 shown in FIG. 12, except for the following points. That is, a height of the monopole antenna 210C in the third direction Z was 13 mm. A height of each of the first parasitic element 222C and the second parasitic element 224C in the third direction Z was 24 mm. The monopole antenna 210C, the first parasitic element 222C, and the second parasitic element 224C were arranged in the second direction Y. When viewed from the third direction Z, the monopole antenna 210C was located on a virtual center line LXC. The first parasitic element 222C and the second parasitic element 224C were located at the equal distance from the monopole antenna 210C. A distance in the second direction Y between the first parasitic element 222C and the second parasitic element 224C was 11 mm. A distance in the first direction X from the front end of the cover 120 to the monopole antenna 210C, the first parasitic element 222C, and the second parasitic element 224C was 70 mm.

In Embodiment 3, as shown in FIG. 16, when where the monopole antenna 210C is not accommodated in the accommodation space 122, the directivity of the monopole antenna 210C is about 6 dBi to 9 dBi around 0°±30° and around 180°±30°, and about −1 dBi to 1 dBi around 90°±30° and around 270°±30°. Accordingly, the first parasitic element 222C and the second parasitic element 224C would make the directivity of the monopole antenna 210C in the positive direction and the negative direction of the first direction X greater than the directivity of the monopole antenna 210C in the positive direction and the negative direction of the second direction Y when the monopole antenna 210C is not accommodated in the accommodation space 122.

In Embodiment 3, as shown in FIG. 15, when the monopole antenna 210C is accommodated in the accommodation space 122, the directivity of the monopole antenna 210C is about 5 dBi to 9 dBi around 0°±30°, about 2 dBi to 10 dBi around 180°±30°, and about 4 dBi to 6 dBi around 90°±30° and around 270°±30°. Accordingly, the first parasitic element 222C and the second parasitic element 224C would make the directivity of the monopole antenna 210C in the positive direction and the negative direction of the first direction X greater than the directivity of the monopole antenna 210C in the positive direction and the negative direction of the second direction Y when the monopole antenna 210C is accommodated in the accommodation space 122.

As can be seen from FIG. 16 of Embodiment 3 and FIG. 8 of Comparative Example 1, the directivity of the monopole antenna 210C in the positive direction and the negative direction of the second direction Y according to Embodiment 3 with the monopole antenna 210C not accommodated in the accommodation space 122 is less than the directivity of the single monopole antenna 210K in the positive direction and the negative direction of the second direction Y according to Comparative Example 1 with the single monopole antenna 210K not accommodated in the accommodation space 122. The directivity of the monopole antenna 210C in the positive direction and the negative direction of the first direction X according to Embodiment 3 with the monopole antenna 210C not accommodated in the accommodation space 122 is greater than the directivity of the single monopole antenna 210K in the positive direction and the negative direction of the first direction X according to Comparative Example 1 with the single monopole antenna 210K not accommodated in the accommodation space 122.

As can be seen from FIG. 15 of Embodiment 3 and FIG. 7 of Comparative Example 1, the directivity of the monopole antenna 210C in the positive direction and the negative direction of the second direction Y according to Embodiment 3 with the monopole antenna 210C accommodated in the accommodation space 122 is less than the directivity of the single monopole antenna 210K in the positive direction and the negative direction of the second direction Y according to Comparative Example 1 with the single monopole antenna 210K accommodated in the accommodation space 122. The directivity of the monopole antenna 210C in the positive direction and the negative direction of the first direction X according to Embodiment 3 with the monopole antenna 210C accommodated in the accommodation space 122 is greater than the directivity of the single monopole antenna 210K in the positive direction and the negative direction of the first direction X according to Comparative Example 1 with the single monopole antenna 210K accommodated in the accommodation space 122.

FIG. 17 is a perspective view of the vehicular antenna device 10D according to Embodiment 4. The vehicular antenna device 10D according to Embodiment 4 is the same as the vehicular antenna device 10A according to Embodiment 1 except for the following points.

The vehicular antenna device 10D according to Embodiment 4 includes a monopole antenna 210D, a first parasitic element 222D, and a second parasitic element 224D. The monopole antenna 210D, the first parasitic element 222D, and the second parasitic element 224D are accommodated in the accommodation space 122. The monopole antenna 210D, the first parasitic element 222D, and the second parasitic element 224D are located within the upper surface of the base 110 in the plan view from the normal direction of the upper surface of the base 110.

The single monopole antenna 210D according to Embodiment 4 is a ½ wavelength monopole antenna. Specifically, the monopole antenna 210D is provided on the upper surface side of the ground plate 20. The monopole antenna 210D is disposed substantially perpendicular to the ground plate 20. A lower end of the monopole antenna 210D facing the ground plate 20 serves as a feeding portion for the monopole antenna 210D. A wavelength of the frequency used in the monopole antenna 210D is defined as λ_{D}. The length of the monopole antenna 210D in the third direction Z is substantially equal to ½ times the wavelength λ_{D}.

When viewed from the third direction Z, the monopole antenna 210D is located on a virtual center line LXD. The virtual center line LXD passes in the first direction X through the substantial center in the second direction Y of the upper surface of the base 110. That is, the virtual center line LXD may also be a central axis of the base 110 in the longitudinal direction corresponding to the first direction X.

The first parasitic element 222D and the second parasitic element 224D are grounded to the ground plate 20. Specifically, a lower end of the first parasitic element 222D and a lower end of the second parasitic element 224D are connected to the ground plate 20. One of the first parasitic element 222D and the second parasitic element 224D, however, may be non-grounded to the ground plate 20. That is, at least one of the first parasitic element 222D and the second parasitic element 224D may be grounded to the ground plate 20.

A length of the first parasitic element 222D in the third direction Z and a length of the second parasitic element 224D in the third direction Z are shorter than a length of the monopole antenna 210D in the third direction Z. The length of the first parasitic element 222D in the third direction Z and the length of the second parasitic element 224D in the third direction Z are substantially longer than ¼ times the wavelength λ_{D}.

The first parasitic element 222D and the second parasitic element 224D are located on opposite sides of a virtual intersection line LYD in the first direction X. The virtual intersection line LYD intersects the virtual center line LXD, and passes through the monopole antenna 210D in the second direction Y. That is, the virtual intersection line LYD may also be a straight line along the lateral direction of the base 110 intersecting the central axis of the base 110 in the longitudinal direction. The monopole antenna 210D and the first parasitic element 222D are therefore arranged in the first direction X. The monopole antenna 210D and the second parasitic element 224D are also arranged in the first direction X. Specifically, the first parasitic element 222D is located on a front side of the virtual intersection line LYD. Thus, the first parasitic element 222D is located between the inner wall of the front side of the cover 120 and the monopole antenna 210D. The second parasitic element 224D is located on a rear side of the virtual intersection line LYD. Thus, the second parasitic element 224D is located between the inner wall of the rear side of the cover 120 and the monopole antenna 210D. The first parasitic element 222D and the second parasitic element 224D can operate as induction elements to induce a radio wave radiated from the monopole antenna 210D. The directivity of the monopole antenna 210D in a desired direction can be therefore enhanced. Specifically, the first parasitic element 222D and the second parasitic element 224D can make the directivity of the monopole antenna 210D in at least one of the positive direction and the negative direction of the first direction X greater than the directivity of the monopole antenna 210D in at least one of the positive direction and the negative direction of the second direction Y.

The monopole antenna 210D, the first parasitic element 222D, and the second parasitic element 224D are arranged in a direction substantially parallel to the first direction X. Specifically, when viewed from the third direction Z, the monopole antenna 210D, the first parasitic element 222D, and the second parasitic element 224D are located on the virtual center line LXD. Accordingly, the directivity of the monopole antenna 210D in at least one of the positive direction and the negative direction of the second direction Y can be further weakened, and the directivity of the monopole antenna 210D in at least one of the positive direction and the negative direction of the first direction X can be further enhanced as compared with a case where the monopole antenna 210D, the first parasitic element 222D, and the second parasitic element 224D are arranged in a direction different from the direction substantially parallel to the first direction X.

In Embodiment 4, a distance in the first direction X between the first parasitic element 222D and the second parasitic element 224D is shorter than a length of the first parasitic element 222D in the third direction Z and a length of the second parasitic element 224D in the third direction Z, and is substantially equal to ¼ times the wavelength λ_{D}.

The first parasitic element 222D and the second parasitic element 224D are located at a substantially equal distance from the monopole antenna 210D. The length of the first parasitic element 222D in the third direction Z and the length of the second parasitic element 224D in the third direction Z are substantially equal to each other. The arrangement and dimensions of the first parasitic element 222D and the second parasitic element 224D, however, are not limited to the arrangement and dimensions according to Embodiment 4. For example, a distance between the monopole antenna 210D and the first parasitic element 222D and a distance between the monopole antenna 210D and the second parasitic element 224D may be different from each other. In this case, the length of the first parasitic element 222D in the third direction Z and the length of the second parasitic element 224D in the third direction Z may be different from each other. Appropriately adjusting the arrangement and dimensions of the first parasitic element 222D and the second parasitic element 224D can enhance the directivity of the monopole antenna 210D in the first direction X.

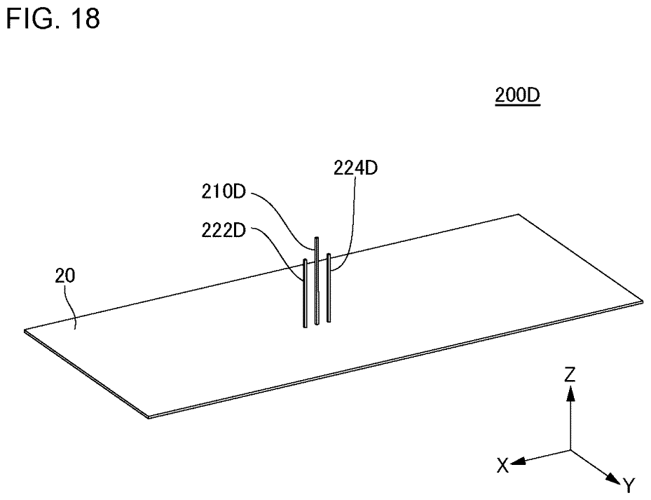

FIG. 18 is a perspective view of an antenna portion 200D according to Embodiment 4. The antenna portion 200D according to Embodiment 4 is the same as the vehicular antenna device 10D according to Embodiment 4 except for the following points.

The antenna portion 200D according to Embodiment 4 does not include the base 110 and the cover 120. The antenna portion 200D according to Embodiment 4 includes the monopole antenna 210D, the first parasitic element 222D, and the second parasitic element 224D as in the vehicular antenna device 10D according to Embodiment 4.

FIG. 18 shows configurations of the monopole antenna 210D, the first parasitic element 222D, and the second parasitic element 224D that are not accommodated in the accommodation space 122. FIG. 18 is a view for comparing the directivity of the monopole antenna 210D accommodated in the accommodation space 122 as shown in FIG. 17 and the directivity of the monopole antenna 210D not accommodated in the accommodation space 122 as shown in FIG. 18.

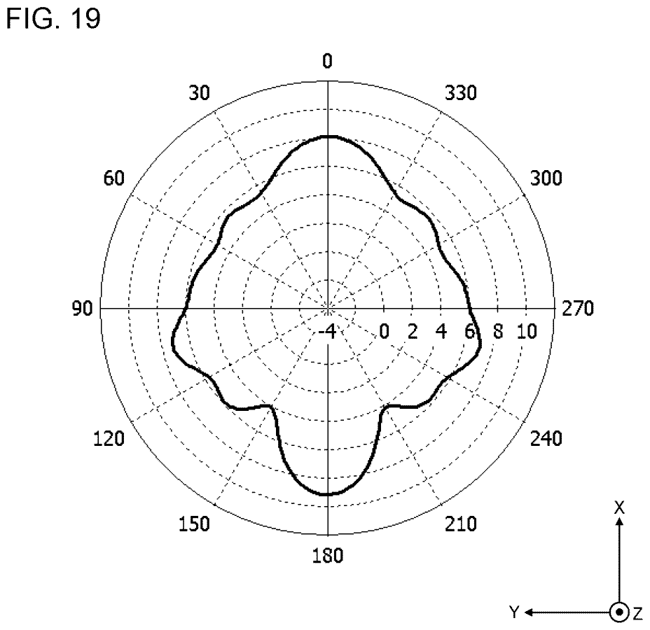

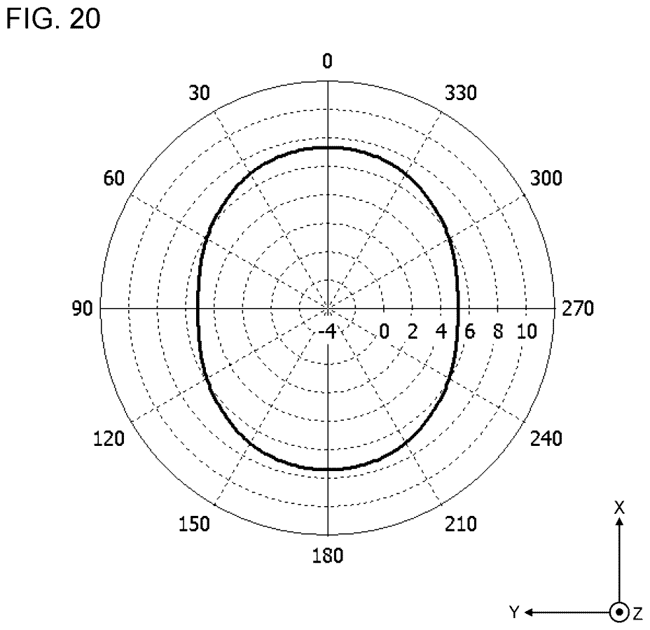

FIG. 19 is a graph showing directivity in the horizontal plane of the monopole antenna 210D in the vehicular antenna device 10D according to Embodiment 4. FIG. 20 is a graph showing directivity in the horizontal plane of the monopole antenna 210D in the antenna portion 200D according to Embodiment 4.

The graphs of FIGS. 19 and 20 show the directivity in the horizontal plane of 5900 MHz, which is a frequency used in the monopole antenna 210D.

The condition of the vehicular antenna device 10D according to Embodiment 4 shown in FIG. 19 and the condition of the antenna portion 200D according to Embodiment 4 shown in FIG. 20 were the same as the condition of the vehicular antenna device 10A according to Embodiment 1 shown in FIG. 5 and the condition of the antenna portion 200A according to Embodiment 1 shown in FIG. 6, except for the following points. That is, a height of the monopole antenna 210D in the third direction Z was 28.5 mm. A height of each of the first parasitic element 222D and the second parasitic element 224D in the third direction Z was 20 mm. When viewed from the third direction Z, the monopole antenna 210D, the first parasitic element 222D, and the second parasitic element 224D were located on the virtual center line LXD. The first parasitic element 222D and the second parasitic element 224D were located at the equal distance from the monopole antenna 210D. A distance in the first direction X between the first parasitic element 222D and the second parasitic element 224D was 11 mm. The distance in the first direction X from the front end of the cover 120 to the monopole antenna 210D was 70 mm.

In Embodiment 4, as shown in FIG. 20, when the monopole antenna 210D is not accommodated in the accommodation space 122, the directivity of the monopole antenna 210D is about 7 dBi around 0°±30° and around 180°±30°, and about 5 dBi to 6 dBi around 90°±30° and around 270°±30°. Accordingly, the first parasitic element 222D and the second parasitic element 224D would make the directivity of the monopole antenna 210D in the positive direction and the negative direction of the first direction X greater than the directivity of the monopole antenna 210D in the positive direction and the negative direction of the second direction Y when the monopole antenna 210D is not accommodated in the accommodation space 122.

In Embodiment 4, as shown in FIG. 19, when the monopole antenna 210D is accommodated in the accommodation space 122, the directivity of the monopole antenna 210D is about 5 dBi to 8 dBi around 0°±30°, about 4 dBi to 9 dBi around 180°±30°, and about 5 dBi to 7 dBi around 90°±30° and around 270°±30°. Accordingly, the first parasitic element 222D and the second parasitic element 224D would make the directivity of the monopole antenna 210D in the positive direction and the negative direction of the first direction X greater than the directivity of the monopole antenna 210D in the positive direction and the negative direction of the second direction Y when the monopole antenna 210D is accommodated in the accommodation space 122.

As can be seen from FIG. 20 of Embodiment 4 and FIG. 8 of Comparative Example 1, the directivity of the monopole antenna 210D in the positive direction and the negative direction of the second direction Y according to Embodiment 4 with the monopole antenna 210D not accommodated in the accommodation space 122 is less than the directivity of the single monopole antenna 210K in the positive direction and the negative direction of the second direction Y according to Comparative Example 1 with the single monopole antenna 210K not accommodated in the accommodation space 122.

As can be seen from FIG. 19 of Embodiment 4 and FIG. 7 of Comparative Example 1, the directivity of the monopole antenna 210D in the positive direction and the negative direction of the second direction Y according to Embodiment 4 with the monopole antenna 210D accommodated in the accommodation space 122 is less than the directivity of the single monopole antenna 210K in the positive direction and the negative direction of the second direction Y according to Comparative Example 1 with the single monopole antenna 210K accommodated in the accommodation space 122. The directivity of the monopole antenna 210D in the negative direction of the first direction X according to Embodiment 4 with the monopole antenna 210D accommodated in the accommodation space 122 is greater than the directivity of the single monopole antenna 210K in the negative direction of the first direction X according to Comparative Example 1 with the single monopole antenna 210K accommodated in the accommodation space 122.

The configurations of the monopole antenna 210D, the first parasitic element 222D, and the second parasitic element 224D are not limited to the configurations described in Embodiment 4.

For example, at least one of the first parasitic element 222D and the second parasitic element 224D may be displaced from the virtual center line LXD to a left side or a right side. The monopole antenna 210D may be displaced from the virtual center line LXD to the right side or the left side. Also in this example, appropriately adjusting predetermined conditions such as the arrangement and the dimensions of the monopole antenna 210D, the first parasitic element 222D, and the second parasitic element 224D can make the directivity of the monopole antenna 210D in at least one of the positive direction and the negative direction of the first direction X greater than the directivity of the monopole antenna 210D in at least one of the positive direction and the negative direction of the second direction Y.

There may be only one parasitic element provided to one monopole antenna 210D. For example, the parasitic element is disposed toward the positive direction of the first direction X with respect to the monopole antenna 210D. Thus, the monopole antenna 210D and the parasitic element are arranged in the first direction X. Accordingly, the directivity of the monopole antenna 210D in the first direction X can be greater than the directivity of the monopole antenna 210D in the direction different from the first direction X.

There may be three or more parasitic elements provided to one monopole antenna 210D. For example, when viewed from the third direction Z, four parasitic elements may be disposed at four vertices of a quadrangle that has two sides parallel to the first direction X and two sides parallel to the second direction Y, and the monopole antenna 210D may be disposed at the center of the quadrangle. Also in this example, adjusting the arrangement of the four parasitic elements in consideration of a predetermined condition such as a phase of a radio wave radiated from the monopole antenna 210D can make the directivity of the monopole antenna 210D in at least one of the positive direction and the negative direction of the first direction X greater than the directivity of the monopole antenna 210D in at least one of the positive direction and the negative direction of the second direction Y.

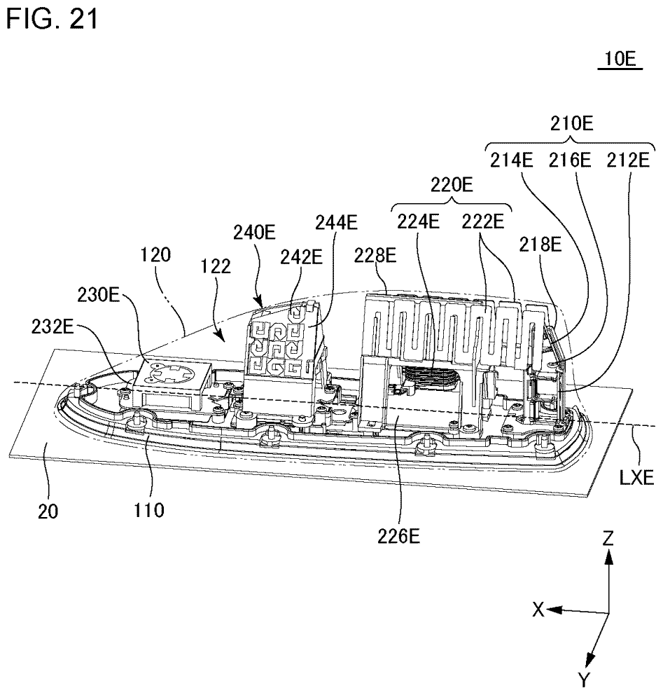

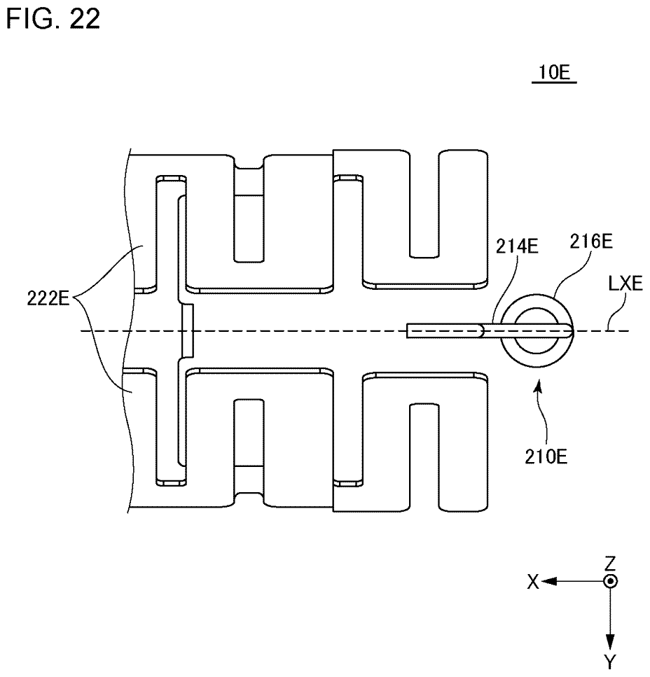

FIG. 21 is a perspective view of the vehicular antenna device 10E according to Embodiment 5. FIG. 22 is an enlarged top view of a collinear array antenna 210E and a pair of first capacitive loading elements 222E in the vehicular antenna device 10E according to Embodiment 5. The vehicular antenna device 10E according to Embodiment 5 is the same as the vehicular antenna device 10B according to Embodiment 2 or the vehicular antenna device 10C according to Embodiment 3, except for the following points.

The vehicular antenna device 10E according to Embodiment 5 is a composite antenna device. Specifically, the vehicular antenna device 10E includes the collinear array antenna 210E, an Amplitude Modulation/Frequency Modulation (AM/FM) antenna 220E, a Global Navigation Satellite System (GNSS) antenna 230E, and a Digital audio Broadcast (DAB) antenna 240E. The collinear array antenna 210E, the AM/FM antenna 220E, the GNSS antenna 230E, and the DAB antenna 240E are accommodated in the accommodation space 122 formed by the cover 120 and the base 110. The collinear array antenna 210E, the AM/FM antenna 220E, the GNSS antenna 230E, and the DAB antenna 240E are located within the upper surface of the base 110 in the plan view from the normal direction of the upper surface of the base 110.

The collinear array antenna 210E is an antenna for performing V2X communication. As shown in FIG. 21, the collinear array antenna 210E is disposed on a rear side of the base 110. As illustrated in FIG. 21, a length of the cover 120 in the first direction X is longer than a length of the cover 120 in the second direction Y. The directivity of the collinear array antenna 210E in at least one of the front direction and the rear direction can be therefore greater than the directivity of the collinear array antenna 210E in the second direction Y. As shown in FIGS. 21 and 22, the collinear array antenna 210E is located on a virtual center line LXE of the base 110 when viewed from the third direction Z. That is, the virtual center line LXE may pass in the first direction X through the substantial center in the second direction Y of the upper surface of the base 110. Accordingly, it is possible to reduce a difference between an influence on the directivity of the collinear array antenna 210E from the inner wall of the cover 120 on a right side of the accommodation space 122 and an influence on the directivity of the collinear array antenna 210E from the inner wall of the cover 120 on a left side of the accommodation space 122. A wavelength of the frequency used in the collinear array antenna 210E is defined as λ_{E}.

The collinear array antenna 210E has a first linear portion 212E, a second linear portion 214E, and an annular portion 216E. The first linear portion 212E, the second linear portion 214E, and the annular portion 216E are conductors such as metal.

The first linear portion 212E is a substantially linear antenna element. As shown in FIG. 21, the first linear portion 212E is disposed substantially perpendicular to the ground plate 20. A lower end portion of the first linear portion 212E serves as a feeding portion. A length of the first linear portion 212E in the third direction Z is adjusted to an appropriate length according to the wavelength λ_{E} of the frequency used in the collinear array antenna 210E. In Embodiment 5, the length of the first linear portion 212E in the third direction Z is substantially equal to, for example, ½ times the wavelength λ_{E}. The length of the first linear portion 212E in the third direction Z may be equal to or more than ⅜ times and equal to or less than ⅝ times the wavelength λ_{E}.

The second linear portion 214E is a substantially linear antenna element. As shown in FIG. 21, the second linear portion 214E is inclined forward from the third direction Z. An upper end portion of the second linear portion 214E is bent forward and is substantially parallel to the first direction X. Accordingly, the height can be reduced with a longer electrical length of the collinear array antenna 210E as compared with a case where the upper end portion of the second linear portion 214E is not bent. The upper end portion of the second linear portion 214E, however, may not be bent. A length of the second linear portion 214E in the third direction Z with the second linear portion 214E extending parallel to the third direction Z without bending the upper end portion of the second linear portion 214E is substantially equal to the length of the first linear portion 212E in the third direction Z. The length of the second linear portion 214E may be, for example, equal to or more than 95% and equal to or less than 105% of the length of the first linear portion 212E.

The annular portion 216E is connected to an upper end portion of the first linear portion 212E and a lower end portion of the second linear portion 214E. As shown in FIGS. 21 and 22, the annular portion 216E is wound around once in a substantially circular shape when viewed from the third direction Z. A phase of the first linear portion 212E and a phase of the second linear portion 214E are aligned by the annular portion 216E.

The collinear array antenna 210E is held by a first holder 218E. The first holder 218E is disposed on an upper surface side of the base 110. The first holder 218E is made of resin, that is, a dielectric. Accordingly, a wavelength of a radio wave transmitted and received in the collinear array antenna 210E can be shortened by the dielectric forming the first holder 218E. The collinear array antenna 210E can be therefore reduced in height as compared with a case where such a wavelength is not shortened.

The AM/FM antenna 220E is an antenna for receiving a radio wave of AM/FM radio broadcast. A frequency used in the AM/FM antenna 220E is different from the frequency used in the collinear array antenna 210E. The AM/FM antenna 220E has a pair of first capacitive loading elements 222E and a helical element 224E.

As shown in FIG. 22, when viewed from the third direction Z, the pair of first capacitive loading elements 222E are disposed on opposite sides of the virtual center line LXE in the second direction Y. Each first capacitive loading element 222E is made of a sheet metal, for example. Each first capacitive loading element 222E has a meander shape. Specifically, each first capacitive loading element 222E is folded back a plurality of times in the third direction Z from a front end portion to a rear end portion of each first capacitive loading element 222E, when viewed from the second direction Y. A shape of the first capacitive loading element 222E, however, is not limited to this example.

An upper end of the helical element 224E is electrically connected to the pair of first capacitive loading elements 222E. A lower end of the helical element 224E is electrically connected to an amplifier substrate 226E. The amplifier substrate 226E is disposed on the upper surface side of the base 110.

As shown in FIG. 21, the pair of first capacitive loading elements 222E are held by a second holder 228E. The second holder 228E is disposed on the upper surface side of the base 110. Rear end portions of the pair of first capacitive loading elements 222E are drawn out behind a rear end portion of the second holder 228E. As shown in FIGS. 21 and 22, when viewed from the third direction Z, the upper end portion of the second linear portion 214E is located between rear end portions of the pair of first capacitive loading elements 222E in the second direction Y. Accordingly, the rear end portion of the first capacitive loading element 222E on the right side is located between the inner wall of the right side of the cover 120 and the upper end portion of the second linear portion 214E. The rear end portion of the first capacitive loading element 222E on the left side is located between the inner wall of the left side of the cover 120 and the upper end portion of the second linear portion 214E. As shown in FIGS. 21 and 22, when viewed from the third direction Z, the first linear portion 212E and the annular portion 216E, on the other hand, are displaced to the rear side with respect to the rear end portions of the pair of first capacitive loading elements 222E.

In Embodiment 5, the pair of first capacitive loading elements 222E may operate as reflective elements to reflect radio waves radiated from the collinear array antenna 210E. In Embodiment 5, the radio waves can be therefore easily induced forwardly from the collinear array antenna 210E due to the reflection of the radio waves by the pair of first capacitive loading elements 222E as compared with a case where the entire collinear array antenna 210E is displaced rearwardly from the rear end portions of the pair of first capacitive loading elements 222E when viewed from the third direction Z. In Embodiment 5, the directivity of the collinear array antenna 210E on the front side can be accordingly enhanced as compared with a case where the entire collinear array antenna 210E is displaced rearwardly from the rear end portions of the pair of first capacitive loading elements 222E when viewed from the third direction Z. Thus, the directivity of the collinear array antenna 210E in a desired direction can be enhanced according to a relationship between a position of the collinear array antenna 210E and a position of the pair of first capacitive loading elements 222E.

In Embodiment 5, the upper end portion of the second linear portion 214E and the rear end portions of the pair of first capacitive loading elements 222E overlap in the second direction Y. In Embodiment 5, the radio waves can be therefore easily induced forwardly from the collinear array antenna 210E due to the reflection of the radio waves by the pair of first capacitive loading elements 222E as compared with a case where the upper end portion of the second linear portion 214E and the rear end portions of the pair of first capacitive loading elements 222E do not overlap in the second direction Y. In Embodiment 5, the directivity of the collinear array antenna 210E on the front side can be accordingly enhanced as compared with a case where the upper end portion of the second linear portion 214E and the rear end portions of the pair of first capacitive loading elements 222E do not overlap in the second direction Y. The upper end portion of the second linear portion 214E and the rear end portions of the pair of first capacitive loading elements 222E, however, may not overlap in the second direction Y. For example, the upper end portion of the second linear portion 214E may be located lower than the lower end of the rear end portions of the pair of first capacitive loading elements 222E.

In Embodiment 5, when viewed from the third direction Z, the first linear portion 212E and the annular portion 216E are displaced rearwardly from the rear end portions of the pair of first capacitive loading elements 222E. That is, when viewed from the third direction Z, a portion of the collinear array antenna 210E is displaced rearwardly from the rear end portions of the pair of first capacitive loading elements 222E. The reflection of radio waves by the pair of first capacitive loading elements 222E on the rear side of the collinear array antenna 210E can be therefore reduced as compared with a case where the entire collinear array antenna 210E is located between the pair of first capacitive loading elements 222E in the second direction Y when viewed from the third direction Z. The directivity of the collinear array antenna 210E on the rear side can be accordingly improved as compared with a case where the entire collinear array antenna 210E is located between the pair of first capacitive loading elements 222E in the second direction Y when viewed from the third direction Z.

In Embodiment 5, the collinear array antenna 210E is disposed in a space present between the pair of first capacitive loading elements 222E. In Embodiment 5, a length of the vehicular antenna device 10E in the first direction X can be therefore shortened as compared with a case where the entire collinear array antenna 210E is displaced rearwardly from the rear end portions of the pair of first capacitive loading elements 222E when viewed from the third direction Z.

In Embodiment 5, the rear end portions of the pair of first capacitive loading elements 222E extend to positions on both sides of the upper end portion of the second linear portion 214E in the second direction Y. In Embodiment 5, the total length of each first capacitive loading element 222E can be therefore increased as compared with a case where the rear end portions of the pair of first capacitive loading elements 222E are displaced forwardly from both sides of the upper end portion of the second linear portion 214E in the second direction Y. A gain of the AM/FM antenna 220E can be thus improved as compared with a case where the rear end portions of the pair of first capacitive loading elements 222E are displaced forwardly from both sides of the upper end portion of the second linear portion 214E in the second direction Y.

The GNSS antenna 230E is an antenna for receiving a GNSS radio wave. The GNSS antenna 230E is disposed on an upper surface side of the GNSS antenna substrate 232E. The antenna substrate 232E is disposed on the upper surface side of the base 110. The GNSS antenna 230E and the GNSS antenna substrate 232E are disposed on the front side of the base 110.

The DAB antenna 240E is an antenna for receiving a DAB radio waves. The DAB antenna 240E has a second capacitive loading element 242E. The second capacitive loading element 242E is held by a third holder 244E. The DAB antenna 240E is disposed between the AM/FM antenna 220E and the GNSS antenna 230E in the first direction X.

The vehicular antenna device 10E according to Embodiment 5 includes the collinear array antenna 210E as a V2X antenna. Other antennas having linear antenna elements, however, may be used as the V2X antenna instead of the collinear array antenna 210E. Examples of other antennas include, for example, a monopole antenna that is substantially perpendicular to the ground plate 20. In this example, when viewed from the third direction Z, at least a portion of the monopole antenna is located between the pair of first capacitive loading elements 222E in the second direction Y.

The vehicular antenna device 10E according to Embodiment 5 includes the AM/FM antenna 220E. The vehicular antenna device 10E, however, may include an antenna that operates only as an FM antenna instead of the AM/FM antenna 220E. This antenna also has a pair of first capacitive loading elements and a helical element as in the AM/FM antenna 220E. When viewed from the third direction Z, at least a portion of the collinear array antenna 210E is located between the pair of first capacitive loading elements in the second direction Y. The antenna that operates only as an FM antenna may not include an AM circuit.

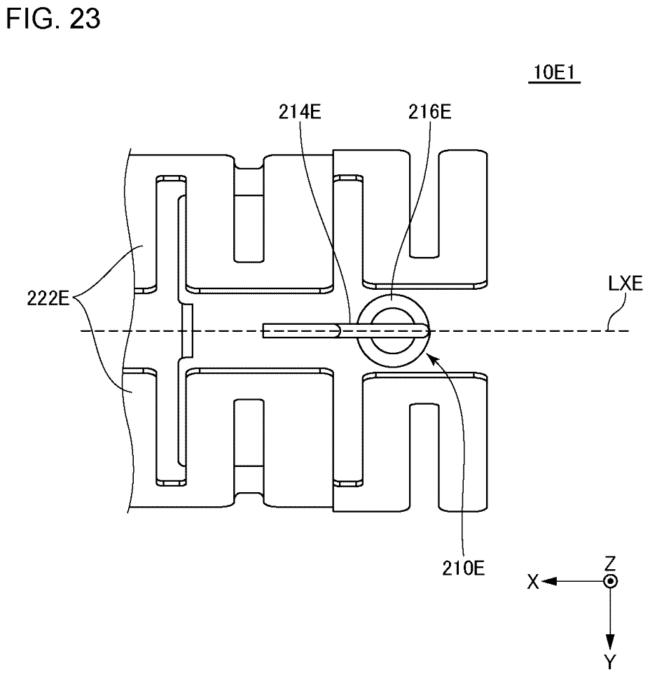

FIG. 23 is an enlarged top view of a collinear array antenna 210E and a pair of first capacitive loading elements 222E in a vehicular antenna device 10E1 according to a variant. The vehicular antenna device 10E1 according to the variant is the same as the vehicular antenna device 10E according to Embodiment 5, except for the following points.

In the variant, when viewed from the third direction Z, the entire collinear array antenna 210E is located between the pair of first capacitive loading elements 222E in the second direction Y. Also in the variant, the pair of first capacitive loading elements 222E may operate as reflective elements to reflect radio waves radiated from the collinear array antenna 210E. In the variant, the radio wave can be further easily induced forwardly from the collinear array antenna 210E by reflection of the radio wave by the pair of first capacitive loading elements 222E on both sides of the collinear array antenna 210E in the second direction Y as compared with Embodiment 5. In the variant, the directivity of the collinear array antenna 210E on the front side can be therefore further enhanced as compared with Embodiment 5.

In the variant, when viewed from the third direction Z, the collinear array antenna 210E is displaced rearwardly from the center of the pair of first capacitive loading elements 222E in the first direction X. The reflection of radio waves by the pair of first capacitive loading elements 222E on the rear side of the collinear array antenna 210E can be therefore reduced as compared with a case where the collinear array antenna 210E is disposed at or around the center of the pair of first capacitive loading elements 222E in the first direction X when viewed from the third direction Z. In the variant, the directivity of the collinear array antenna 210E on the rear side can be accordingly improved as compared with a case where the collinear array antenna 210E is disposed at or around the center of the pair of first capacitive loading elements 222E in the first direction X when viewed from the third direction Z.

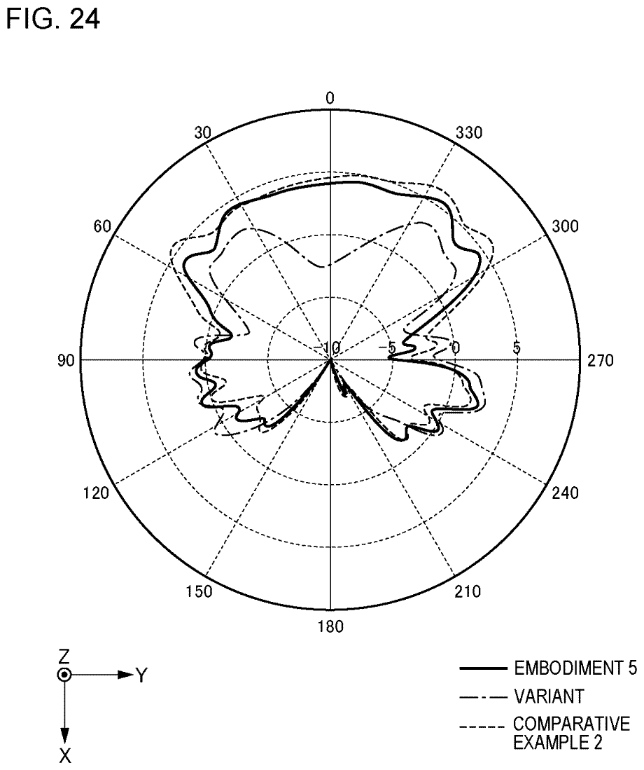

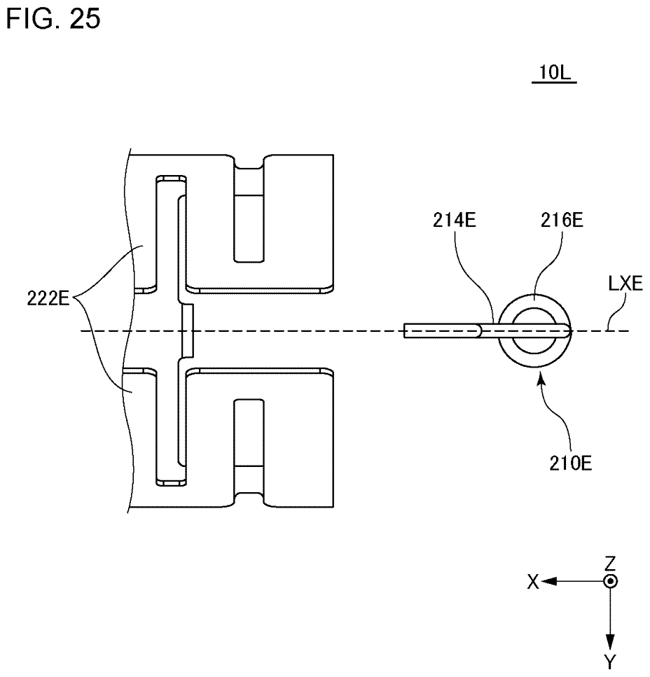

FIG. 24 is a graph showing directivity in the horizontal plane of the collinear array antenna 210E in each of the vehicular antenna device 10E according to Embodiment 5, the vehicular antenna device 10E1 according to the variant, and a vehicular antenna device 10L according to Comparative Example 2. FIG. 25 is an enlarged top view of a collinear array antenna 210E and a pair of first capacitive loading elements 222E in the vehicular antenna device 10L according to Comparative Example 2. The vehicular antenna device 10L according to Comparative Example 2 is the same as the vehicular antenna device 10E according to Embodiment 5, except that the entire collinear array antenna 210E is displaced rearwardly from the rear end portions of the pair of first capacitive loading elements 222E when viewed from the third direction Z.

In FIG. 24, the directivity in the horizontal plane of the collinear array antenna 210E according to Embodiment 5 is indicated by a solid line. The directivity in the horizontal plane of the collinear array antenna 210E according to the variant is indicated by a dash-dot line. The directivity in the horizontal plane of the collinear array antenna 210E according to Comparative Example 2 is indicated by a broken line. Each directivity in the horizontal plane in FIG. 24 indicates the directivity in the horizontal plane of the collinear array antenna 210E with the collinear array antenna 210E accommodated in the accommodation space 122.

In FIG. 24, numbers attached to an outer periphery of the graph indicate directions (unit: °) in the horizontal plane. The angles of 180°, 0°, 270°, and 90° are the front direction, the rear direction, the left direction, and the right direction, respectively.

In FIG. 24, the conditions of Embodiment 5, the variant, and Comparative Example 2 are as follows.

A length from front end portions to rear end portions of the pair of first capacitive loading elements 222E is 80 mm in Embodiment 5, 92 mm in the variant, and 68 mm in Comparative Example 2.

In Embodiment 5, when viewed from the third direction Z, the upper end portion of the second linear portion 214E is located between the pair of first capacitive loading elements 222E in the second direction Y. The upper end portion of the second linear portion 214E overlaps the pair of first capacitive loading elements 222E in the second direction Y. When viewed from the third direction Z, the first linear portion 212E is displaced rearwardly by 6 mm from the rear end portions of the pair of first capacitive loading elements 222E.

In the variant, when viewed from the third direction Z, the entire collinear array antenna 210E is located between the pair of first capacitive loading elements 222E in the second direction Y. The upper end portion of the second linear portion 214E and the pair of first capacitive loading elements 222E overlap in the second direction Y. When viewed from the third direction Z, the first linear portion 212E is displaced forwardly by 5.5 mm from the rear end portions of the pair of first capacitive loading elements 222E.

In Comparative Example 2, when viewed from the third direction Z, the entire collinear array antenna 210E is displaced rearwardly from the rear end portions of the pair of first capacitive loading elements 222E. When viewed from the third direction Z, the first linear portion 212E is displaced rearwardly by 17.5 mm from the rear end portions of the pair of first capacitive loading elements 222E.

In FIG. 24, Embodiment 5 is compared with Comparative Example 2.

The directivity at and around 120° and the directivity at or around 240° in Embodiment 5 are higher than the directivity at or around 120° and the directivity at or around 240° in Comparative Example 2. This results suggests the directivity of the collinear array antenna 210E on the front side can be improved when at least a portion of the collinear array antenna 210E is located between the pair of first capacitive loading element 222E in the second direction Y when viewed from the third direction Z as compared with when the entire collinear array antenna 210E is displaced rearwardly from the rear end portion of the first capacitive loading element 222E when viewed from the third direction Z.

In FIG. 24, Embodiment 5 is compared with the variant.

The directivity at and around 120° and the directivity at or around 240° in the variant are higher than the directivity at or around 120° and the directivity at or around 240° in Embodiment 5. This result suggests the directivity of the collinear array antenna 210E on the front side can be improved when the entire collinear array antenna 210E is located between the pair of first capacitive loading element 222E in the second direction Y when viewed from the third direction Z as compared with when a portion of the collinear array antenna 210E is displaced rearwardly from the rear end portion of the first capacitive loading element 222E when viewed from the third direction Z.

The directivity at and around 0°, the directivity at and around 45° and the directivity at or around 315° in Embodiment 5 are higher than the directivity at or around 0°, the directivity at and around 45°, and the directivity at or around 315° in the variant. This result suggests the directivity of the collinear array antenna 210E on the rear side can be improved when a portion of the collinear array antenna 210E is displaced rearwardly from the rear end portion of the first capacitive loading element 222E when viewed from the third direction Z as compared with when the entire collinear array antenna 210E is located between the pair of first capacitive loading elements 222E in the second direction Y when viewed from the third direction Z.

Although the above embodiments and variants focus on the shark-fin-shaped vehicular antenna device and the like mounted over the roof of the vehicle, the vehicular antenna device according to the present invention is not limited to the above embodiments and variants.

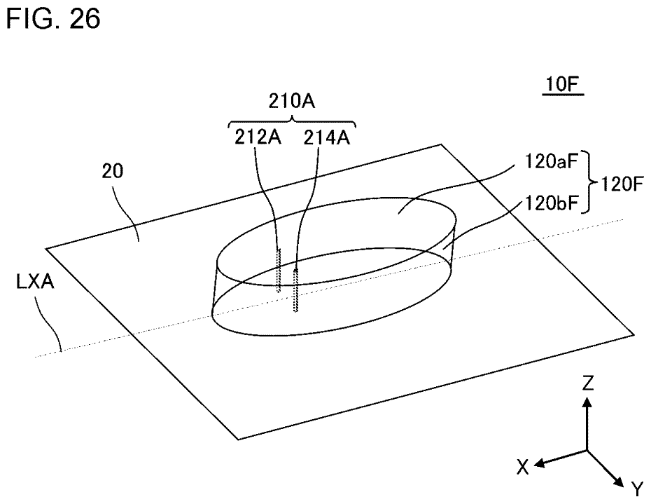

The vehicular antenna device may have an elliptic cover. For example, FIG. 26 is a perspective view of a vehicular antenna device 10F according to Embodiment 6. The vehicular antenna device 10F according to Embodiment 6 is the same as the vehicular antenna device 10A according to Embodiment 1 except for the following points.

As shown in FIG. 26, the vehicular antenna device 10F includes a cover 120F. The cover 120F includes an elliptical top surface 120aF when viewed in a plan view of the first direction X and the second direction Y plane from the third direction Z, and a cylindrical member 120bF extending, in the negative direction of the third direction Z, from the outer periphery of the top surface 120aF. As shown in FIG. 26, the major diameter of the top surface 120aF is in the first direction X and the minor diameter of the top surface 120aF is in the second direction Y. In Embodiment 6, the cylindrical member 120bF is formed such that when the cover 120F is installed at the ground plate 20 placed on the first direction X and the second direction Y plane, the ground plate 20 and the top surface 120aF are substantially parallel, and the angle formed by the ground plate 20 and the cylindrical member 120bF is approximately 90°. In one example, the major diameter of the top surface 120aF in the first direction X is 220 mm, the minor diameter of the top surface 120aF in the second direction Y is 110 mm, and the height of the cylindrical member 120bF in the third direction Z, that is, the distance from the ground plate 20 to the top surface 120aF, is 55 mm.

The vehicular antenna device 10F according to Embodiment 6 includes an array antenna 210A accommodated in an accommodation space formed by the cover 120F, as in the vehicular antenna device 10A according to Embodiment 1. The first monopole antenna 212A and the second monopole antenna 214A are located on opposite sides of the virtual center line LXA. According to Embodiment 6, the directivity of the array antenna 210A accommodated in the accommodation space formed by the cover 120F can be enhanced in the desired direction with a simple configuration.

In another example, the vehicular antenna device 10F according to Embodiment 6 may include a monopole antenna 210B, 210C or 210D, a first parasitic element 222B, 222C or 222D and a second parasitic element 224B, 224C or 224D according to Embodiment 2, 3 or 4, respectively, accommodated in the accommodation space formed by the cover 120F. In still another example, the vehicular antenna device 10F according to Embodiment 6 may include a collinear array antenna 210E and an AM/FM antenna 220E according to Embodiment 5 accommodated in the accommodation space formed by the cover 120F. According to the examples, the directivity of the antenna accommodated in the accommodation space formed by the cover 120F can be enhanced in the desired direction with a simple configuration.

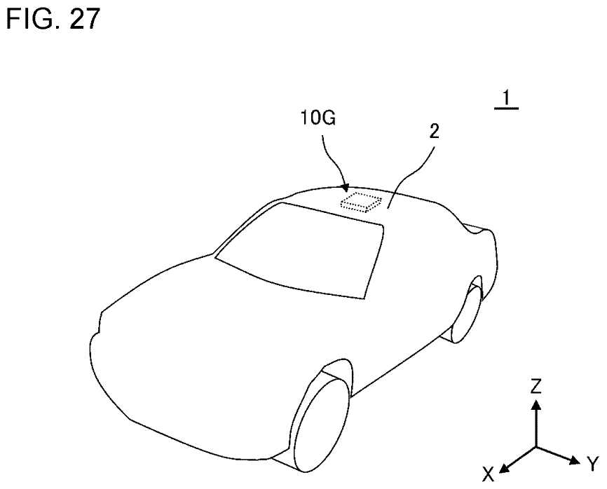

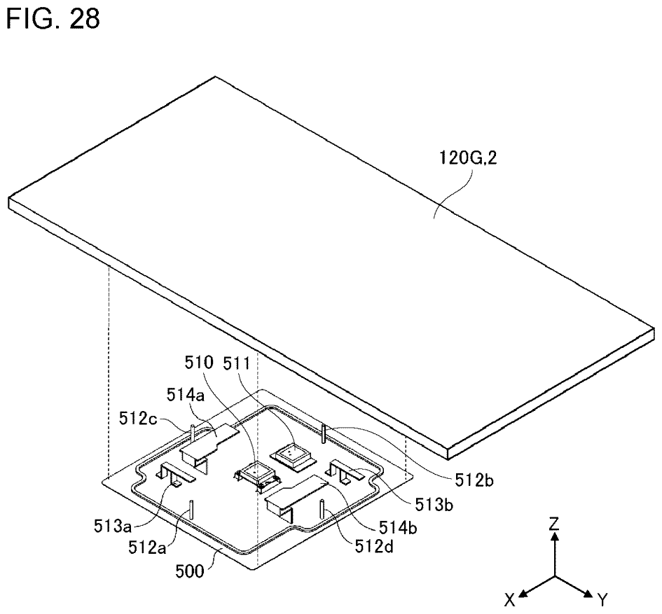

The vehicular antenna device may be a so-called hidden antenna or flat antenna. For example, FIG. 27 is a perspective view of a vehicle 1 in which a vehicular antenna device 10G according to Embodiment 7 is mounted. FIG. 28 is an exploded perspective view of the vehicular antenna device 10G according to Embodiment 7. The vehicular antenna device 10G according to Embodiment 7 is the same as the vehicular antenna device 10A according to Embodiment 1 except for the following points.

In Embodiment 7, as shown in FIGS. 27 and 28, a portion of a roof panel 2 of the vehicle 1 corresponds to a cover 120G. The roof panel 2 is made of, for example, resin, glass, or the like having radio wave transmission property. For example, the vehicular antenna device 10G is accommodated in a cavity between the roof panel 2 and the roof lining in the ceiling surface of the interior of the vehicle 1. The cavity corresponds to an accommodation space 122 according to Embodiment 1.

The vehicular antenna device 10G according to Embodiment 7 is a compound antenna device including a plurality of antennas operating in different frequency bands. As shown in FIG. 28, the vehicular antenna device 10G according to Embodiment 7 includes a metal base 500, a patch antenna 510, a planar antenna 511, a first V2X antenna 512a, a second V2X antenna 512b, a third V2X antenna 512c, a fourth V2X antenna 512d, a first 5G antenna 513a, a second 5G antenna 513b, a first LTE/5G antenna 514a, and a second LTE/5G antenna 514b. The first V2X antenna 512a, the second V2X antenna 512b, the third V2X antenna 512c, and the fourth V2X antenna 512d may be collectively referred to V2X antennas 512a to 512d. The first 5G antenna 513a and the second 5G antenna 513b may be collectively referred to 5G antennas 513a and 513b. The first LTE/5G antenna 514a and the second LTE/5G antenna 514b may be collectively referred to LTE/5G antennas 514a and 514b.

The metal base 500 is a substantially quadrilateral metal plate used as a ground common to the patch antenna 510, the planar antenna 511, V2X antennas 512a to 512d, the 5G antennas 513a and 513b, and the LTE/5G antennas 514a and 514b, and is installed on the roof lining of the vehicle 1. The metal base 500 is a thin plate extending over the front, rear, right, and left directions.

The patch antenna 510 is compatible with SDARS (Satellite Digital Audio Radio Service) system, for example, and receives left-hand circularly polarized waves in the 2.3 GHz band. The patch antenna 510 is installed near the center of metal base 500.

The planar antenna 511 is compatible with GNSS (Global Navigation Satellite System), for example, and receives radio waves in the 1.5 GHz band from an artificial satellite. The planar antenna 511 is installed in the rear (the negative direction of the first direction X) of the patch antenna 510.

The V2X antennas 512a to 512d are antennas supporting vertically polarized waves in the V2X frequency band. Each of the V2X antennas 512a to 512d is arranged around the patch antenna 510. Specifically, the first V2X antenna 512a and the second V2X antenna 512b are respectively arranged on the front and rear sides of the patch antenna 510, and the third V2X antenna 512c and the fourth V2X antenna 512d are respectively arranged on the right and left sides of the patch antenna 510.

In Embodiment 7, the first V2X antenna 512a mainly supports vertically polarized waves from the front (the positive direction of the first direction X), the second V2X antenna 512b mainly supports vertically polarized waves from the rear (the negative direction of the first direction X), the third V2X antenna 512c mainly supports vertically polarized waves from the right side (the negative direction of the second direction Y), and the fourth V2X antenna 512d mainly supports vertically polarized waves from the left side (the positive direction of the second direction Y). The vehicular antenna device 10G includes a plurality of V2X antennas 512a to 512d with different directivities, thereby being able to receive desired radio waves using a diversity system.

The 5G antennas 513a and 513b are, for example, telematics antennas compatible with the fifth-generation mobile communication system. The 5G antennas 513a and 513b transmit and receive radio waves in the Sub-6 band defined by the standards of the fifth-generation mobile communication system.

The LTE/5G antennas 514a and 514b are, for example, telematics antennas compatible with Long Term Evolution (LTE) and fifth-generation mobile communication systems. The LTE/5G antenna 514a and 514b transmits and receives radio waves in the 700 MHz to 2.7 GHz frequency band defined by the LTE standards. Further, the LTE/5G antennas 514a and 514b also transmits and receives radio waves in the Sub-6 band defined by the standards of the fifth-generation mobile communication system, that is, frequency bands from 3.6 GHz to less than 6 GHz.

The communication standards and frequency bands applicable to the patch antenna 510, the planar antenna 511, the V2X antennas 512a to 512d, the 5G antennas 513a and 513b, and the LTE/5G antennas 514a and 514b are not limited to those described above, and other communication standards and frequency bands may be used.

When the first direction X is a desired direction, the third V2X antenna 512c and the fourth V2X antenna 512d according to Embodiment 7, which are arranged in a direction intersecting the desired direction, would correspond to the first monopole antenna 212A and the second monopole antenna 214A according to Embodiment 1, respectively. According to Embodiment 7, the directivity of the third V2X antenna 512c and the fourth V2X antenna 512d in the first direction X can be enhanced with the third V2X antenna 512c and the fourth V2X antenna 512d accommodated in the accommodation space.

When the second direction Y is a desired direction, the first V2X antenna 512a and the second V2X antenna 512b according to Embodiment 7, which are arranged in a direction intersecting the desired direction, would correspond to the first monopole antenna 212A and the second monopole antenna 214A according to Embodiment 1, respectively. According to Embodiment 7, the directivity of the first V2X antenna 512a and the second V2X antenna 512b in the second direction Y can be enhanced with the first V2X antenna 512a and the second V2X antenna 512b accommodated in the accommodation space.

In another example, the vehicular antenna device 10G according to Embodiment 7 may include a monopole antenna 210B, 210C or 210D, a first parasitic element 222B, 222C or 222D and a second parasitic element 224B, 224C or 224D according to Embodiment 2, 3 or 4, respectively, accommodated in the accommodation space formed by the cover 120G. In still another example, the vehicular antenna device 10G according to Embodiment 7 may include a collinear array antenna 210E and an AM/FM antenna 220E according to Embodiment 5 accommodated in the accommodation space formed by the cover 120F. According to the examples, the directivity of the antenna accommodated in the accommodation space formed by the cover 120G can be enhanced in the desired direction with a simple configuration.

Although the embodiments and variants of the present invention have been described with reference to drawings, these are mere examples of the present invention, and various other configurations other than those given above may be adopted.

The antenna device according to the embodiments and variants may be mounted over the vehicle, attached to the vehicle, brought in the vehicle, or used in the vehicle. The antenna device according to the embodiments and variants is not limited to use with “vehicle”, which is a wheeled vehicle, but may be used with a moving object such as a flying object such as a drone, a probe, an unwheeled construction equipment, agriculture equipment, and a ship, for example.

According to the present specification, the following aspects are provided.

### (Aspect 1)

Aspect 1 is a vehicular antenna device including: a cover; a plurality of monopole antennas accommodated in an accommodation space formed by the cover, in which the plurality of monopole antennas is arranged in a desired direction.

According to Aspect 1, the interference between radio waves radiated from each of the plurality of monopole antennas occurs between the plurality of monopole antennas. This can enhance the directivity of the plurality of monopole antennas in the direction intersecting the virtual line segment for connecting two monopole antennas included in the plurality of monopole antennas. The directivity of the plurality of monopole antennas in the desired direction can be therefore enhanced. The configuration of each of the plurality of monopole antennas can be made simpler than the configurations of other antennas such as dipole antennas. The vehicular antenna device can therefore have a relatively simple configuration.

### (Aspect 2)

Aspect 2 is the vehicular antenna device according to Aspect 1, in which the plurality of monopole antennas is arranged in a direction substantially perpendicular to the desired direction.

According to Aspect 2, the directivity of the plurality of monopole antennas in the desired direction can be further enhanced as compared with a case where the plurality of monopole antennas is arranged in a direction different from the direction substantially perpendicular to the desired direction.

### (Aspect 3)

Aspect 3 is the vehicular antenna device according to Aspect 1 or 2, further including a base having a first surface, in which the plurality of monopole antennas is located within the first surface in a plan view from a normal direction of the first surface, and is located substantially symmetrically with respect to a virtual line that passes in a direction substantially parallel to the desired direction through a center of the first surface.

According to Aspect 3, it is possible to reduce a difference between an influence on the directivity of the plurality of monopole antennas from the cover on one side of the virtual line in the accommodation space and an influence on the directivity of the plurality of monopole antennas from the cover on the other side of the virtual line in the accommodation space.

### (Aspect 4)

Aspect 4 is the vehicular antenna device according to any one of Aspects 1 to 3, in which a length of the cover in the desired direction is longer than a length of the cover in a direction intersecting the desired direction.

According to Aspect 4, the directivity of the monopole antenna in the desired direction can be enhanced.

### (Aspect 5)

Aspect 5 is the vehicular antenna device according to any one of Aspects 1 to 4, further including a base having a first surface, in which the plurality of monopole antennas is located within the first surface in a plan view from a normal direction of the first surface, and is located at a center of the first surface in the desired direction or at a distance of 45% or less of a total length in the desired direction from the center of the first surface.

According to Aspect 5, it is possible to reduce a difference between an influence on the directivity of the monopole antenna from one side of the cover in the desired direction and an influence on the directivity of the monopole antenna from the other side of the cover in the desired direction.

### (Aspect 6)

Aspect 6 is a vehicular antenna device including: a cover; a monopole antenna accommodated in an accommodation space formed by the cover; and a parasitic element accommodated in the accommodation space, in which the monopole antenna and the parasitic element are arranged in a direction intersecting a desired direction.

According to Aspect 6, the directivity of the monopole antenna in the desired direction can be enhanced by making the parasitic element operate as a reflective element to reflect a radio wave radiated from the monopole antenna. The directivity of the monopole antenna in the desired direction can be therefore enhanced. The configuration of the monopole antennas can be made simpler than the configurations of other antennas such as dipole antennas. The vehicular antenna device can therefore have a relatively simple configuration.

### (Aspect 7)

Aspect 7 is the vehicular antenna device according to Aspect 6, in which the monopole antenna and the parasitic element are arranged in a direction substantially perpendicular to the desired direction.

According to Aspect 7, the directivity of the monopole antenna in the desired direction can be further enhanced as compared with a case where the monopole antenna and the parasitic element are arranged in a direction different from the direction substantially perpendicular to the desired direction.

### (Aspect 8)

Aspect 8 is the vehicular antenna device according to Aspect 6 or 7, in which at least two parasitic elements are located on opposite sides of a virtual line that passes through the monopole antenna in a direction substantially parallel to the desired direction.

According to Aspect 8, the directivity of the monopole antenna in the desired direction can be enhanced by making at least two parasitic elements operate as reflective elements to reflect a radio wave radiated from the monopole antenna. The directivity of the monopole antenna in the desired direction can be therefore enhanced.

### (Aspect 9)

Aspect 9 is the vehicular antenna device according to any one of Aspects 6 to 8, in which at least two parasitic elements are arranged in a direction substantially perpendicular to the desired direction.

According to Aspect 9, the directivity of the monopole antenna in the desired direction can be further enhanced as compared with a case where at least two parasitic elements are arranged in a direction different from the direction substantially perpendicular to the desired direction.

### (Aspect 10)

Aspect 10 is the vehicular antenna device according to any one of Aspects 6 to 9, in which the parasitic element is non-grounded.

According to Aspect 10, the parasitic element can operate as a reflective element to reflect a radio wave radiated from the monopole antenna.

### (Aspect 11)

Aspect 11 is the vehicular antenna device according to any one of Aspects 6 to 10, in which the parasitic element is located between an inner wall of the cover and the monopole antenna.

According to Aspect 11, the directivity of the monopole antenna in the desired direction can be enhanced with the parasitic element located between the inner wall of the cover and the monopole antenna.

### (Aspect 12)

Aspect 12 is the vehicular antenna device according to any one of Aspects 6 to 11, further including a base having a first surface, in which the monopole antenna is located within the first surface in a plan view from a normal direction of the first surface, and is located on a virtual line that passes in a direction substantially parallel to the desired direction through a substantial center of the first surface.

According to Aspect 12, it is possible to reduce a difference between an influence on the directivity of the monopole antenna from the cover on one side of the virtual line in the accommodation space and an influence on the directivity of the monopole antenna from the cover on the other side of the virtual line in the accommodation space.

### (Aspect 13)

Aspect 13 is the vehicular antenna device according to any one of Aspects 6 to 12, in which a length of the cover in the desired direction is longer than a length of the cover in a direction intersecting the desired direction.

According to Aspect 13, the directivity of the monopole antenna in the desired direction can be enhanced.

### (Aspect 14)

Aspect 14 is the vehicular antenna device according to any one of Aspects 6 to 13, further including a base having a first surface, in which the monopole antenna is located within the first surface in a plan view from a normal direction of the first surface, and is located at a center of the first surface in the desired direction or at a distance of 45% or less of a total length in the desired direction from the center of the first surface.

According to Aspect 14, it is possible to reduce a difference between an influence on the directivity of the monopole antenna from one side of the cover in the desired direction and an influence on the directivity of the monopole antenna from the other side of the cover in the desired direction.

### (Aspect 15)

Aspect 15 is a vehicular antenna device including: a cover; a monopole antenna accommodated in an accommodation space formed by the cover; and a parasitic element accommodated in the accommodation space, in which the monopole antenna and the parasitic element are arranged along a desired direction.

According to Aspect 15, the directivity of the monopole antenna in the desired direction can be enhanced by making the parasitic element operate as an induction element to induce a radio wave radiated from the monopole antenna. The directivity of the monopole antenna in the desired direction can be therefore enhanced. The configuration of the monopole antennas can be made simpler than the configurations of other antennas such as dipole antennas. The vehicular antenna device can therefore have a relatively simple configuration.

### (Aspect 16)

Aspect 16 is the vehicular antenna device according to Aspect 15, in which at least two parasitic elements are located on opposite sides of a virtual line that passes through the monopole antenna in a direction substantially perpendicular to the desired direction.

According to Aspect 16, the directivity of the monopole antenna in the desired direction can be enhanced by making at least two parasitic elements operate as induction elements to induce a radio wave radiated from the monopole antenna. The directivity of the monopole antenna in the desired direction can be therefore enhanced.

### (Aspect 17)

Aspect 17 is the vehicular antenna device according to Aspect 15 or 16, in which at least two parasitic elements are arranged in a direction substantially parallel to the desired direction.

According to Aspect 17, the directivity of the monopole antenna in the desired direction can be further enhanced as compared with a case where at least two parasitic elements are arranged in a direction different from the direction substantially parallel to the desired direction.

### (Aspect 18)

Aspect 18 is the vehicular antenna device according to any one of Aspects 15 to 17, in which the parasitic element is grounded.

According to Aspect 18, the parasitic element can operate as an induction element to induce a radio wave radiated from the monopole antenna.

### (Aspect 19)

Aspect 19 is the vehicular antenna device according to any one of Aspects 15 to 18, in which the parasitic element is located between an inner wall of the cover and the monopole antenna.

According to Aspect 19, the directivity of the monopole antenna in the desired direction can be enhanced with the parasitic element located between the inner wall of the cover and the monopole antenna.

### (Aspect 20)

Aspect 20 is the vehicular antenna device according to any one of Aspects 15 to 19, further including a base having a first surface, in which the monopole antenna is located within the first surface in a plan view from a normal direction of the first surface, and is located on a virtual line that passes in a direction substantially parallel to the desired direction through a substantial center of the first surface.

According to Aspect 20, it is possible to reduce a difference between an influence on the directivity of the monopole antenna from the cover on one side of the virtual line in the accommodation space and an influence on the directivity of the monopole antenna from the cover on the other side of the virtual line in the accommodation space.

### (Aspect 21)

Aspect 21 is the vehicular antenna device according to any one of Aspects 15 to 20, in which a length of the cover in the desired direction is longer than a length of the cover in a direction intersecting the desired direction.

According to Aspect 21, the directivity of the monopole antenna in the desired direction can be enhanced.

### (Aspect 22)

Aspect 22 is the vehicular antenna device according to any one of Aspects 15 to 21, further including a base having a first surface, in which the monopole antenna is located within the first surface in a plan view from a normal direction of the first surface, and is located at a center of the first surface in the desired direction or at a distance of 45% or less of a total length in the desired direction from the center of the first surface.

According to Aspect 22, it is possible to reduce a difference between an influence on the directivity of the monopole antenna from one side of the cover in the desired direction and an influence on the directivity of the monopole antenna from the other side of the cover in the desired direction.

### (Aspect 23)

Aspect 23 is a vehicular antenna device including: a cover; an antenna element accommodated in an accommodation space formed by the cover; and a pair of capacitive loading elements accommodated in the accommodation space and disposed in a direction intersecting a desired direction, in which at least a portion of the antenna element is located between the pair of capacitive loading elements.

According to Aspect 23, the radio wave can be easily induced from the antenna element toward the desired direction due to the reflection of the radio wave by the pair of capacitive loading elements as compared with a case where the entire antenna element is displaced from the pair of capacitive loading elements in the desired direction. According to Aspect 23, the directivity of the antenna element in the desired direction can be therefore enhanced as compared with a case where the entire antenna element is displaced from the pair of capacitive loading elements. Thus, the directivity of the antenna element in the desired direction can be enhanced according to a relationship between a position of the antenna element and a position of the pair of capacitive loading elements.

### (Aspect 24)

Aspect 24 is the vehicular antenna device according to Aspect 23, in which the at least a portion of the antenna element is displaced from a center of the pair of capacitive loading elements in the desired direction.

According to Aspect 24, the reflection of the radio wave by the pair of capacitive loading elements on a side toward which the antenna element is displaced from the center of the capacitive loading element can be reduced as compared with a case where the antenna element is disposed at or around the center of the pair of capacitive loading elements in the desired direction. According to Aspect 24, the directivity of the antenna element on the side toward which the antenna element is displaced from the center of the capacitive loading element can be therefore improved as compared with a case where the antenna element is disposed at or around the center of the pair of capacitive loading elements in the desired direction.

### (Aspect 25)

Aspect 25 is the vehicular antenna device according to Aspect 23 or 24, in which another portion of the antenna element is displaced from the pair of capacitive loading elements in the desired direction.

According to Aspect 25, the reflection of the radio wave by the pair of capacitive loading elements on a side toward which the other portion of the antenna element is displaced from the pair of capacitive loading element can be reduced as compared with a case where the entire antenna element is located between the pair of capacitive loading elements. According to Aspect 25, the directivity of the antenna element on a side toward which the other portion of the antenna element is displaced from the pair of capacitive loading element can be therefore improved as compared with a case where the entire antenna element is located between the pair of capacitive loading elements.

### (Aspect 26)

Aspect 26 is the vehicular antenna device according to any one of Aspects 23 to 25, in which the at least a portion of the antenna element and at least a portion of the pair of capacitive loading elements overlap in a direction substantially perpendicular to the desired direction.

According to Aspect 26, the radio wave can be easily induced from the antenna element toward the desired direction due to the reflection of the radio wave by the pair of capacitive loading elements as compared with a case where at least a portion of the antenna element and at least a portion of a pair of the capacitive loading elements do not overlap in the direction substantially perpendicular to the desired direction. According to Aspect 26, the directivity of the antenna element in the desired direction can be therefore enhanced.

### (Aspect 27)

Aspect 27 is the vehicular antenna device according to any one of Aspects 23 to 26, further including a base having a first surface, in which the antenna element is located within the first surface in a plan view from a normal direction of the first surface, and is located on a virtual line that passes in a direction substantially parallel to the desired direction through a substantial center of the first surface.

According to Aspect 27, it is possible to reduce a difference between an influence on the directivity of the antenna element from the cover on one side of the virtual line in the accommodation space and an influence on the directivity of the antenna element from the cover on the other side of the virtual line in the accommodation space.

### (Aspect 28)

Aspect 28 is the vehicular antenna device according to any one of Aspects 23 to 27 in which a length of the cover in the desired direction is longer than a length of the cover in a direction intersecting the desired direction.

According to Aspect 28, the directivity of the antenna element in the desired direction can be enhanced.

### REFERENCE SIGNS LIST

1 vehicle, 2 roof panel, 10A, 10B, 10C, 10D, 10E, 10E1, 10F, 10G, 10K, 10L vehicular antenna device, 20 ground plate, 110 antenna base or base, 120, 120F, 120G cover or antenna case, 120aF top surface, 120bF cylindrical member, 122 accommodation space, 200A, 200B, 200C, 200D, 200K antenna portion, 210A array antenna, 210B, 210C, 210D, 210K monopole antenna, 212A first monopole antenna, 214A second monopole antenna, 222B, 222C, 222D first parasitic element, 224B, 224C, 224D second parasitic element, 210E collinear array antenna, 212E first linear portion, 214E second linear portion, 216E annular portion, 218E first holder, 220E AM/FM antenna, 222E first capacitive loading element, 224E helical element, 226E amplifier substrate, 228E second holder, 230E GNSS antenna, 232E GNSS antenna substrate, 240E DAB antenna, 242E second capacitive loading element, 244E third holder, 500 metal base, 510 patch antenna, 511 planar antenna, 512a first V2X antenna, 512b second V2X antenna, 512c third V2X antenna, 512d fourth V2X antenna, 513a first 5G antenna, 513b second 5G antenna, 514a first LTE/5G antenna, 514b second LTE/5G antenna, LXA, LXB, LXC, LXD, LXE, LXK virtual center line, LYA, LYB, LYC, LYD virtual intersection line, X first direction, Y second direction, Z third direction

What is claimed is:

1. A vehicular antenna device comprising:
a cover; and
a plurality of monopole antennas accommodated in an accommodation space formed by the cover,
wherein the plurality of monopole antennas is arranged in a direction intersecting a desired direction.

2. The vehicular antenna device according to claim 1,
wherein the plurality of monopole antennas is arranged in a direction substantially perpendicular to the desired direction.

3. The vehicular antenna device according to claim 1, further comprising:
a base having a first surface,
wherein the plurality of monopole antennas is located within the first surface in a plan view from a normal direction of the first surface, and is located substantially symmetrically with respect to a virtual line that passes in a direction substantially parallel to the desired direction through a center of the first surface.

4. The vehicular antenna device according to claim 1,
wherein a length of the cover in the desired direction is longer than a length of the cover in a direction intersecting the desired direction.

5. The vehicular antenna device according to claim 1, further comprising:
a base having a first surface,
wherein the plurality of monopole antennas is located within the first surface in a plan view from a normal direction of the first surface, and is located at a center of the first surface in the desired direction or at a distance of 45% or less of a total length in the desired direction from the center of the first surface.
